(19) United States
(12) Patent Application Publication
(10) Pub. No.: US 2023/0321918 A1
(43) Pub. Date: Oct. 12, 2023

(54) AS-DEPOSITED DATA MODEL FOR DIRECTING MACHINING AFTER ADDITIVE MANUFACTURING

(71) Applicant: 3D SYSTEMS, INC., Rock Hill, SC (US)

(72) Inventors: Alexander Gabriel Steinberg, Woodland Park, CO (US); Rex Thomas Alexandre, Laguna Vista, TX (US)

(21) Appl. No.: 18/184,946

(22) Filed: Mar. 16, 2023

Related U.S. Application Data
(63) Continuation-in-part of application No. 16/837,696, filed on Apr. 1, 2020, now Pat. No. 11,638,965.
(60) Provisional application No. 62/827,527, filed on Apr. 1, 2019.

(51) Int. Cl. B29C 64/393; B29C 64/10; B33Y 50/02

(52) U.S. Cl. CPC B29C 64/393; B29C 64/10; B33Y 50/02; B33Y 10/00

(57) ABSTRACT

In the context of additive manufacturing processes wherein objects are built by layered accumulations of discrete instantaneous deposits of feedstock material at specific locations according to a first three-dimensional digital data model, processes and systems are provided for first forming an oversized blank part that roughly conforms to the first model and is subsequently machined to final dimensions specified by the first model. Various embodiments provide for generating a second model representing the expected shape of the blank part, as formed by a discrete deposition process, and facilitating calculation of specific toolpaths by which material removal tools may render the final shape.

### REFERENCE TO RELATED APPLICATIONS

This application claims the priority benefit of U.S. Provisional Patent App. No. 62/827,527, filed Apr. 1, 2019, and U.S. patent application Ser. No. 16/837,696, filed Apr. 1, 2020, both of which are incorporated herein by reference in their entireties.

### TECHNICAL FIELD

Embodiments of the technology relate, in general, to systems and methods for fabricating a component via additive manufacturing using a non-continuous deposition process.

### BACKGROUND

Additive manufacturing (AM) has made great strides over the past decade as popular AM processes such as Laser Powder Bed Fusion (LPBF), Electron Beam Melting (EBM), and Selective Laser Sintering (SLS) have transitioned away from strictly high-end R&D projects to a much broader range of productionized applications. While advances in the aforementioned technologies are being made on a frequent basis, they also have their limitations. These common processes have limited build volumes and low deposition rates, sometimes resulting in parts that can take weeks and even months to complete. The high cost of equipment and of the fine-grained powders used in these processes is also a limiting factor in their widespread adoption. The high costs involved have typically limited applications to high performance, lightweight aerospace parts that require intensive and time-consuming qualification requirements before a single part can be used for a specific application, further increasing the cost of adoption.

Due to the cost and size limitations inherent in LPBF, EBM, and SLS, a wide range of varying AM modalities based on melting, sintering, or solid-state processing are being developed with the intent to build larger parts at higher deposition rates for a lower cost. Two of the more popular processes currently offered on the market include Directed Energy Deposition (DED) and Wire Arc Additive Manufacturing (WAAM). DED systems are typically expensive and difficult to operate, given that they utilize high-power lasers and complex motion systems such as 5-axis CNC platforms or 6+ axis robotic systems. The material costs associated with DED are also fairly high as the standard feedstock is still a fine powder. Furthermore, 10-50% of all powder used in DED is lost, adding to the cost of each part produced. The WAAM concept was designed to overcome the capital and material costs of DED by utilizing standard arc welding processes such as Gas Metal Arc Welding (GMAW), Gas Tungsten Arc Welding (GTAW), and Plasma Arc Welding (PAW) along with standard weld filler metal in the wire form. Typical WAAM systems are designed around 6-axis welding robots to further reduce costs. Despite the attractive cost and lead time reduction of a robot over a CNC platform for both DED and WAAM, the dynamic accuracy of robotic systems while following a toolpath is limited, increasing the likelihood of manufacturing defects such as lack of fusion. While WAAM successfully combats the capital and material cost issues of DED, it is faced with poorer surface finishes along with higher heat inputs and residual stresses as deposition rates increase.

Even if the cost issue can be eliminated by selecting WAAM over DED, one of the most pressing issues limiting the widespread adoption of all large scale AM processes is that of toolpath generation and motion control. Existing slicing software and toolpath generation methods for large scale AM are focused primarily on either the generation of simplistic shapes, or are developed for very specific geometric applications. A “universal” slicer does not yet exist, and thus programmers and machine operators can thus be forced to spend days or weeks writing code to run large scale AM machines. Once code has been written and is ready for implementation on the factory floor, finding skilled operators familiar with both CNC or robot-based codes and the deposition process can be incredibly difficult, often resulting in higher personnel costs to run machines as engineers are utilized instead of technicians. As additive manufacturing continues to mature, the need for a simple and robust, high throughput, low-cost machine must be met before AM fully revolutionizes manufacturing around the world. As cost is reduced and accessibility is increased, AM will make its way into low-criticality applications with ease, thus increasing the adoption rate of the technology worldwide.

### SUMMARY

In the context of additive manufacturing, the present teachings disclose one or more methods, processes and systems for forming a three-dimensional object within a build space from at least one feedstock material. In accordance with embodiments disclosed, material is deposited in discrete increments at specification locations in the build space in conformance to a first digital data model describing at least the object's outer surface. The manner of non-continuous and discrete deposition taught herein, unlike continuous extrusion of a material performed by other processes, yields particular advantages and results in a blank part having a coarse outer shape that is intended to undergo subsequent machining to a final shape as specified by the first digital data model.

In some embodiments, an array of voxel spaces spatially dividing a build space in three dimensions is defined, establishing a pattern of locations as candidate positions at which to deposit unitary masses of material. The array is compared to the first digital data model to identify a required subset of voxel spaces in the array that must be occupied by the feedstock material such that feedstock material is present at all points along the object's outer surface according to the first digital data model. Because a contour of the object's final shape is unlikely to exactly align with boundaries of the patterned voxel spaces, the depositing of material into the required voxel spaces results in an outer surface of the blank part that has rough but predictable protrusions beyond the model surface. In some embodiments, a second digital data model is created to represent the predicted coarse shape of the blank part, including the protruding parts, and the second digital data model is provided, along with the first digital data model, to a tool path computing application in a computing environment to instruct the motion of a cutting tool or the like that removes material from the blank part to render the final part.

In some embodiments, an additive manufacturing system is set forth that includes a material-removal tool that moves in accordance with the instructions from the tool path computing application. In some embodiments, the material-removal tool may operate within the same build space as the additive process that builds the blank part.

### BRIEF DESCRIPTION OF THE DRAWINGS

Various exemplary embodiments are illustrated by way of example, and not by way of limitation, in the following detailed description, claims and accompanying drawings, in which like reference numerals refer to similar elements and in which:

FIG. 1 is a right isometric view depicting a fabrication system, in accordance with one embodiment;

FIG. 2 is a left isometric view depicting the fabrication system of FIG. 1;

FIG. 3 is a top plan view of a component layer deposited in accordance with an embodiment;

FIG. 4 is an isometric view of a plurality of fabrication systems in accordance with another embodiment;

FIGS. 5A and 5B are an isometric view and a cross-sectional view of a contact tip in accordance with another embodiment;

FIG. 6 is a isometric view of a rotatable housing including multiple contact tips in accordance with another embodiment;

FIG. 7 depicts an end effector capable associated with more than one wire feeder in accordance with another embodiment;

FIG. 8 is an isometric view of a component layer deposited in accordance with an embodiment;

FIG. 9 is an isometric view of a component layer having deposited cells of varying sizes in accordance with an embodiment;

FIGS. 10A-10G are isometric views of a component layer as it is being deposited in accordance with an embodiment;

FIG. 11 is a front plan view of a blank during post-process machining in accordance with another embodiment;

FIG. 12 depicts a software architecture chart in accordance with another embodiment;

FIG. 13 depicts a software architecture chart in accordance with another embodiment;

FIGS. 14A through 14H depict two example processes for depositing material in a single-mass transfer in accordance with an embodiment;

FIG. 15 depicts a regular pattern of voxel spaces as may be applied in accordance with one or more embodiments;

FIG. 16 depicts a data structure comprising locations for material deposits in accordance with one or more embodiments;

FIG. 17 is a pictorial describing a sequence for depositing material into specific voxel locations in accordance with one or more embodiments;

FIG. 18 is a conceptual diagram outlining stages of processing a data model representing the outer surface of an object to be constructed in accordance with an embodiment;

FIG. 19 depicts the inclusion of specific voxel spaces within an array in fulfillment of a given object layer contour in accordance with one or more embodiments;

FIG. 20 is a conceptual diagram showing an example sequence of material deposits for a pattern of voxels in accordance with one or more embodiments;

FIG. 21 depicts the actions of a material depositing device in alternately moving to, and depositing material at, prescribed deposit locations in accordance with one or more embodiments;

FIG. 22 depicts a process for generating an initial sequential list of deposit locations from an object's layer slice data in accordance with one or more embodiments;

FIG. 23 presents a process for additively fabricating a blank part while monitoring for a need to change delay time between deposits in accordance with one or more embodiments;

FIGS. 24A through 24D are timing diagrams for explaining coordination among depositor movements, depositing actions and the execution of logical processes in accordance with one or more embodiments;

FIGS. 25A through 25C depict various scenarios as to sequences in which vicinal voxel spaces may be filled in accordance with one or more embodiments;

FIG. 26 presents a heat map superimposed on a pattern of voxel spaces which are to be filled with material according to a first sequence of material deposits in accordance with one or more embodiments;

FIG. 27 presents, in contrast to FIG. 26, an alternative heat map resulting from altering the first sequence to form a second sequence of material deposits in accordance with one or more embodiments;

FIG. 28 depicts a process for simulating the additive formation of a part blank according to an initial sequential list of deposit locations and rearranging the sequential list responsive to characteristics observed during the simulation in accordance with one or more embodiments;

FIG. 29 depicts a process for performing the additive formation of a part blank according to an initial sequential list of deposit locations and rearranging the sequential list responsive to observations of the partially formed blank in accordance with one or more embodiments;

FIGS. 30A through 30D are pictorial representations of an object contour overlaid upon a voxel space pattern in various positions to show differences in excess material in accordance with one or more embodiments;

FIG. 31 depicts an overhang feature upon a partially constructed part blank being additively formed in accordance with one or more embodiments;

FIG. 32 describes a process for iteratively comparing various positionings between an object contour and voxel space patterns to reduce an amount of excess material deposited in accordance with one or more embodiments;

FIG. 33 is a pictorial showing comparatively smaller voxel outlines applied to implementing an object contour in accordance with one or more embodiments;

FIGS. 34A and 34B depict the subdividing of a voxel space into smaller spaces and the redistribution of the latter as deposit locations in a sequential list in accordance with one or more embodiments; and

FIG. 35 is a block diagram for providing both a final object model and an as-deposited model of a blank to a subsequent process that calculates tool paths for removing excess material from the blank to form the final object in accordance with one or more embodiments.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Systems and methods specifically described herein and illustrated in the accompanying drawings are by way of example and are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of apparatuses, systems, and methods for making a component via additive manufacturing with non-continuous deposition. The component may be a blank for a part. In one example embodiment, software for toolpath generation takes a 3D model and fills it with a series of layers of hexagonally packed cells that create the complete volume of the given part. The cells are then sorted to build a toolpath consisting of a series of discrete deposition events (i.e., each event corresponds to a single deposited cell). In some embodiments, the cells are sorted to allow for rapid traversals between the discrete deposition events in an order that is designed to maximize deposition rates while residual stress and distortion are minimized by controlling heat input throughout the part. As used herein, references to modeled cell(s) or cell(s) refer to the discrete unit making up the cellular model, which is used to create an order of the discrete deposition events during the non-continuous deposition process, as discussed further below. Each cell is associated with a deposited cell to be deposited during the non-continuous deposition process. As used herein, deposited cell(s) refers to the individual physical depositions that form the blank of a part or the part. As used herein, the term ‘voxel’ may also be used to refer to one of array of elements that conceptually subdivide a three-dimensional space. Each voxel has a unique location and bounds within the three-dimensional space. Thus, even though a voxel is an abstract entity, it may be appropriately said that material is deposited to fill a given ‘voxel space’ meaning at a location within the build space corresponding to a voxel's relative location and bounds as applied to that build space. A voxel space having been filled with material constitutes a deposited cell. Costs are reduced and industrial reliability is maintained by utilizing a variant of the standard GMAW process to build each deposited cell until they are joined together and form the final part. The non-continuous, discrete deposition nature of the process allows for modular scalability of machines without interference in the process or build quality.

In various embodiments, the component formed using a non-continuous deposition process as described herein can be understood to be a “blank” that is further milled or otherwise shaped into a final part. By fabricating the component using the deposited cell-by-deposited cell, layer-by-layer process described. herein, the resultant blank can have a configuration that roughly resembles the final part but does not have the associated cost and complexity associated with conventional metal additive manufacturing processes such as, for example, conventional Directed Energy Deposition (DED), Laser Powder Bed Fusion (LPBF), Electron Beam Melting (EBM), and Selective Laser Sintering (SLS). The deposited cell-by-deposited cell, layer-by-layer process can replace rough machining operations carried out on large billets and bar stock that are costly and time consuming. Solely machining a final product from bar stock may be sub-optimal and, likewise, generating a final part using only conventional metal additive manufacturing may also be sub-optimal.

The examples discussed herein are examples only and are provided to assist in the explanation of the apparatuses, devices, systems and methods described herein. None of the features or components shown in the drawings or discussed below should be taken as mandatory for any specific implementation of any of the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

In general, it will be apparent that at least some of the embodiments described herein can be implemented in many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that skilled persons would be able to design software and control hardware to implement the embodiments based on the present description with no more than reasonable effort and without undue experimentation.

Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the processes described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semi-permanent, and/or semi-temporary.

A “computer,” “computer system,” “host,” “server,” or “processor” can be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments. The memory can also include any means for storing software, including a hard disk, an optical disk, floppy disk, ROM (read only memory), RAM (random access memory), PROM (programmable ROM), EEPROM (electrically erasable PROM) and/or other computer-readable media. Non-transitory computer-readable media, as used herein, comprises all computer-readable media except for a transitory, propagating signals.

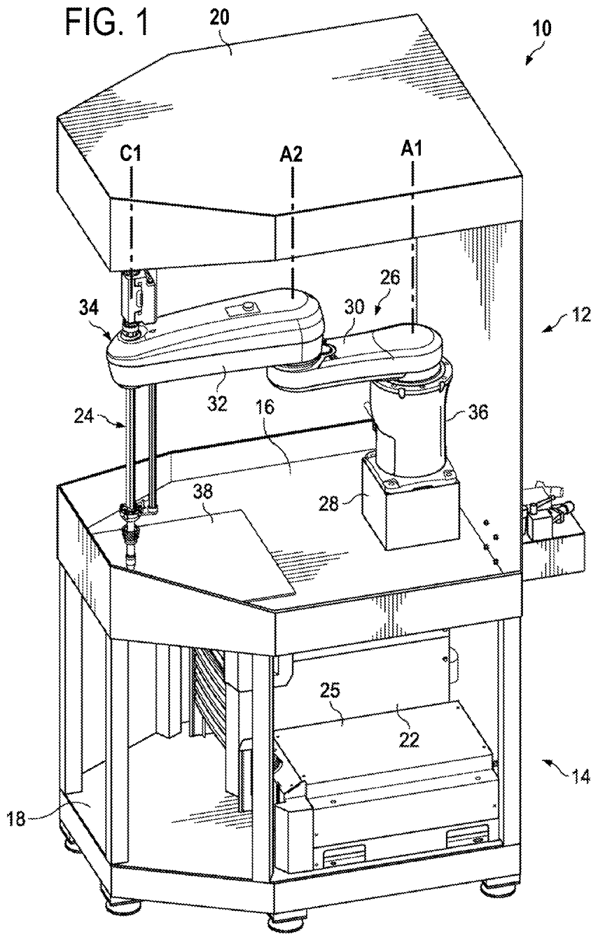

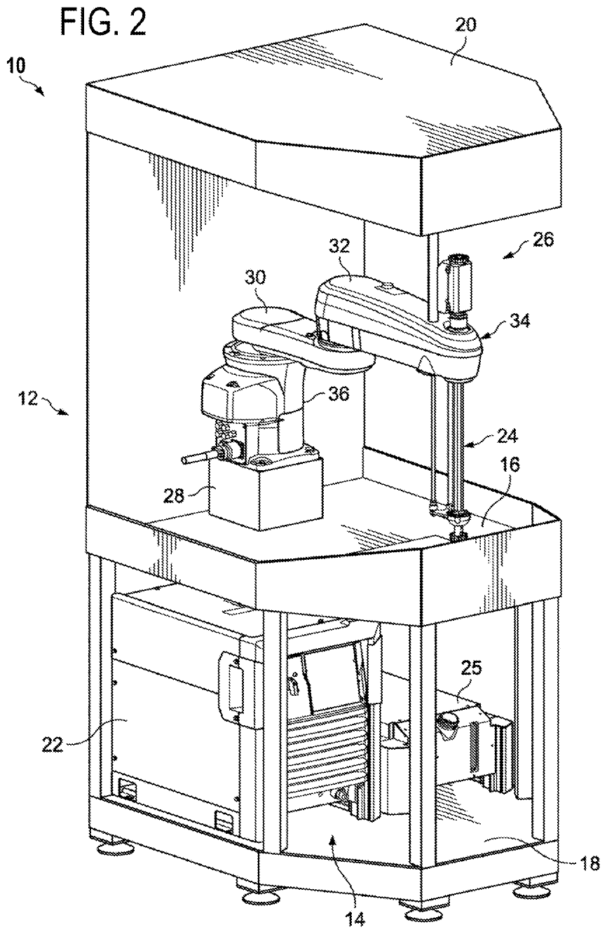

Embodiments are hereinafter described in detail in connection with the views and examples of FIGS. 1-35, wherein like numbers indicate the same or corresponding elements throughout the views. A fabrication system 10 is generally depicted in FIGS. 1 and 2 and can facilitate fabrication of a metal component via additive manufacturing, as will be described in further detail below. The fabrication system 10 can include a frame assembly 12 and a deposition system, such as welding system 14. The frame assembly 12 can include a welding table 16, a lower shelf 18 disposed beneath the welding table 16, and a hood 20 disposed above and extending over the welding table 16. In one embodiment, the frame assembly 12 can be formed of steel, but in other embodiments, the frame assembly 12 can be formed of any of a variety of suitable alternative materials, such as other metals, plastics, and/or composites, such as epoxy-granite.

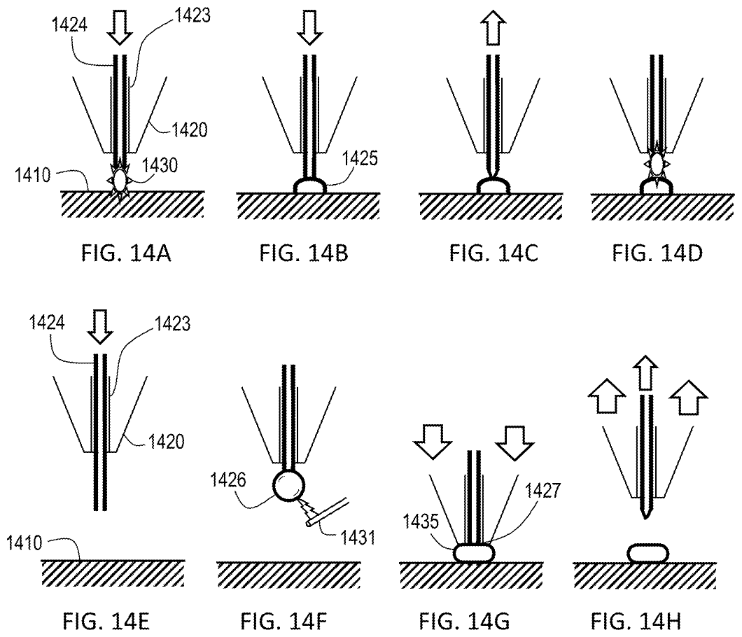

The welding system 14, which can be for example any suitable deposition system, can include a welding machine 22 and a weld gun 24 that is coupled to the welding machine 22 via a cable assembly (not shown). The welding system 14 can include a chiller 25. The welding machine 22 can selectively feed welding wire to the weld gun 24 (via the cable assembly) as part of a welding process, as is commonly understood in the art. It is to be appreciated that the welding machine 22 and the weld gun 24 can be configured to accommodate any of a variety of suitable welding processes, such as, for example, Gas Metal Arc Welding (GMAW), Gas Tungsten Arc Welding (GT/kW), and Plasma Arc Welding (PAW). Some processes that are amenable to the present teachings are explained in connection with FIG. 14.

The weld gun 24 can be coupled with an articulated robot 26 that is disposed on the frame assembly 12 or welding table 16 beneath the hood 20. In an embodiment, the welding machine is configured to begin feeding the welding wire through the weld gun 24 while the articulated robot 26 is moving. In this manner, the tip of the welding wire may be in the appropriate position to begin arc initiation as the weld gun 24 reaches the next weld location. For example, the initiation time may be from 10 milliseconds to 100 milliseconds and the movement time may be from 50 milliseconds to 900 milliseconds, such that combining the initiation phase with the movement phase may reduce the overall time required for the overall weld. The arc initiation can begin simultaneously or immediately after the articulated robot 26 completes the movement of the weld gun 24. During the welding process, welding gasses emitted from the weld gun 24 can be at least partially collected by the hood 20. In one embodiment, a fume extraction system (not shown) can be associated with the hood 20 and can facilitate extraction of the welding gases from the welding table 16. In another embodiment, welding gases may be recirculated in an enclosed chamber in order to maintain an inert atmosphere.

During the welding process, the articulated robot 26 can facilitate selective positioning of the weld gun 24 relative to the welding table 16. In one embodiment, as illustrated in FIGS. 1 and 2, the articulated robot 26 can comprise a Selective Compliance Articulated Robot Arm (SCARA) robot that includes a base 28, a first arm 30, and a second arm 32. The base 28 can be coupled with the frame assembly 12 or the welding table 16. The first arm 30 can be pivotally coupled with the base 28 and pivotable with respect to the base 28 about a first axis A1. The second arm 32 can be pivotally coupled with the first arm 30 (at an end opposite the base 28) and pivotable with respect to the first arm 30 about a second axis A2. Each of the first and second arms 30, 32 can accordingly be pivoted about the first and second axes A1, A2, respectively, to move the weld gun 24 laterally along the welding table 16 (e.g., in an X-Y direction) It will be appreciated that the articulated robot can include any suitable components or features to facilitate movement about additional axes such as, for example, by providing a rotating wrist joint (not shown) that can rotate about a Z-axis. The articulated robot 26 may also include a mount (not shown) on the distal end thereof to provide a 5th controlled axis allowing for an azimuth-elevation tool axis control. The weld gun 24 also can be slidably coupled with a distal end 34 of the second arm 32 and slidable along a centerline C1 such that the weld gun 24 is moveable vertically with respect to the welding table (e.g., in a Z direction). The articulated robot 26 can accordingly provide three degrees of freedom for the weld gun 24. In another embodiment, the welding table 16 can include a rotisserie or trunnion (not shown) to facilitate printing on cylindrical components as the cylindrical components are rotated about an axis.

In one embodiment, each of the weld gun 24, the first arm 30, and the second arm 32 can be associated with respective servos (not shown) that can be independently controlled to move the weld gun 24, the first arm 30, and the second arm 32 relative to each other. In other embodiments, any of a variety of suitable alternative electronic actuators can be used to facilitate automated movement of the weld gun 24, the first arm 30, and the second arm 32. It is to be appreciated that although the articulated robot 26 is illustrated and described above to be a SCARA robot, any of a variety of suitable alternative robot arrangements are contemplated for positioning the weld gun 24 relative to the welding table 16 (e.g., a delta robot, 6-axis robot arm, or gantry machine). The time it takes the articulated robot 26 to move the weld gun 24 may vary. In some embodiments, the move time may be in a range of 0.01 s to 100 s, 0.01 s to 50 s, 0.01 s to 10 s, 0.01 s to 1 s, 0.01 s to 0.5 s, 0.1 s to 0.5 s, 0.1 s to 1 s, 0.1 to 10 s, 0.1 s to 100 s, 0.5 s to 1 s, 0.5 s to 10 s, 0.5 s to 100 s, 1 s to 10 s, 1 s to 50 s, or 1 s to 100 s. In an embodiment, the articulated robot 26 may move from 1 m/min to 60 m/min.

Still referring to FIGS. 1 and 2, the welding system 14 can include a controller 36 that is associated with the welding machine 22, the weld gun 24, and the articulated robot 26. While the controller 36 is shown in connection with the articulated robot 26, the controller 36 may be a separate component (e.g., in an electrical cabinet (not shown)). The controller 36 can facilitate control of the welding process (via the welding machine 22 and/or the weld gun 24) and the operation of the articulated robot 26 to fabricate a three-dimensional component on the welding table 16 via additive manufacturing, as will be described in further detail below. The controller 36 can include native software that can provide instructions to the welding machine 22 and the articulated robot 26 based upon an input from a user (via a control panel or a computer model). In one embodiment, the controller 36 can be a general-purpose computer but, in other embodiments, the controller 36 can be any of a variety of suitable alternative controller arrangements for controlling the welding process and operation of the articulated robot 26.

The welding machine 22 and the controller 36 are shown to be disposed on the lower shelf 18 beneath the welding table 16. A spool or container of welding wire (not shown) can also be provided on the lower shelf 18. By arranging each of these components on the frame assembly 12, the fabrication system 10 can be a self-contained unit that is easily transportable. In one embodiment, the frame assembly 12 can have an overall length and width that is similar to a standard pallet (e.g., about 40 inches by about 48 inches) to enable the fabrication system 10 to be easily transported with pallet moving equipment, such as a pallet jack or a forklift, for example.

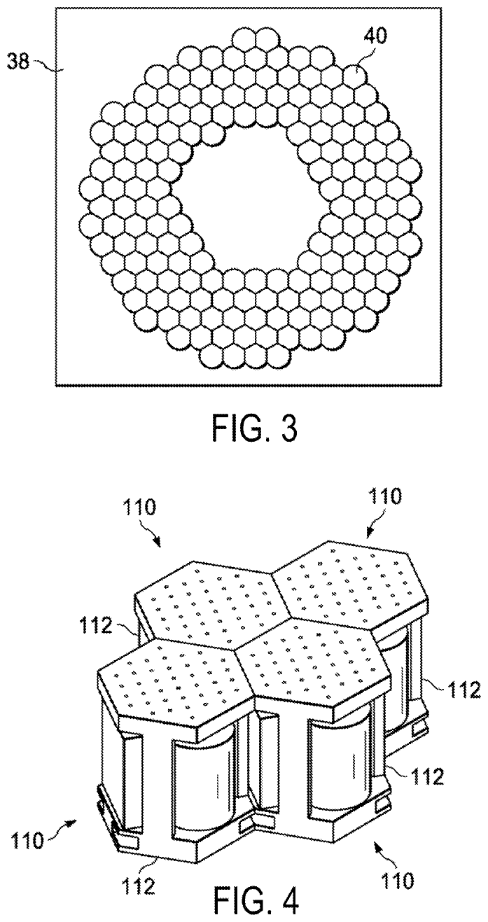

Referring now to FIG. 3, the welding system 14 can fabricate a metal component on a weld plate 38 by depositing a plurality of deposited cells 40 on the weld plate 38. During the welding process, the substrate (e.g., weld plate 38) may be preheated to a desired temperature. In some embodiments, the preheat temperature may be in a range of 0° C. to 1000° C., 0° C. to 750° C., 0° C. to 500° C., 0° C. to 250° C., 10° C. to 1000° C., 10° C. to 500° C., 20° C. to 1000° C., 20° C. to 500° C., 50° C. to 1000° C., or 50° C. to 500° C. Each consecutive deposited cell 40 that is deposited on the weld plate 38 can be spaced from the deposited cell 40 that was previously deposited. For example, the deposited cells 40 can be deposited in a non-continuous manner (i.e., where a continuous manner of deposition would be placing the next deposited cell 40 directly adjacent the previous deposited cell 40). Deposited cells rapidly placed in close proximity can result in a propensity to agglomerate and become asymmetric. By depositing the deposited cells 40 in a non-continuous manner, each particular deposited cell 40 can be allowed to properly cool before another deposited cell 40 is deposited thereon. The approach can enhance the bonding between the deposited cells 40 and distribute the heat input across the metal component to reduce the likelihood for imperfections in the metal component.

The welding parameters may vary. In some embodiments, the voltage applied may be in a range of 10 V to 40 V, 10 V to 30 V, 10 V to 20 V, 15 V to 25 V, 15 V to 35 V, 20 V to 30 V, 20 V to 40 V, or 30 V to 40 V. Various embodiments can include an applied current of 10 A to 1000 A, 10 A to 500 A, 10 A to 250 A, 10 A to 100 A, 100 A to 250 A, 100 A to 400 A, 100 A to 500 A, 100 A to 750 A, 250 A to 500 A, 250 A to 750 A, 500 A to 750 A, or 500 A to 1000 A. The duty cycle may be in a range of 0% to 100%, 25% to 100%, 25% to 90%, 25% to 75%, 40% to 100%, 40% to 90%, or 40% to 75%. The length of the unmelted wire extending from the weld gun (wire stick out) and wire feed rate may vary. In some embodiments, the wire stick out may be in a range of 1 mm to 50 mm, 1 mm to 40 mm, 1 mm to 30 mm, 1 mm to 20 mm, 5 mm to 50 mm, 5 mm to 35 mm, 10 mm to 50 mm. 10 mm to 40 mm, 10 mm to 30 mm, 10 mm to 25 mm, 12 mm to 25 mm 15 mm to 25 mm, 15 mm to 35 mm, 20 mm to 40 mm, or 20 mm to 30 mm. In various embodiment, the wire feed rate (inches per minute) may be in a range of 10 to 1500, 10 to 1250, 10 to 1000, 10 to 500, 50 to 1500, 50 to 1000, 50 to 500, 100 to 1500, 100 to 1250, 100 to 750, 100 to 500, 100 to 250, 250 to 1250, 250 to 1000, 250 to 500, 500 to 1500, 500 to 1000, 750 to 1500, 1000 to 1500. Additionally, the arc-on tune may vary and, in some embodiments, can be in a range of 0.01 s to 100 s, 0.01 s to 50 s, 0.01 s to 10 s, 0.01 s to I s, 0.1 s to 100 s, 0.1 s to 50 s, 0.1 s to 10 s, 0.1 s to s, 0.2 s to 1.00 s, 0.2 s to 50 s, 0.2 s to 10 s, 0.2 s to 1 s, 0.5 s to 50 s, 0.5 s to 10 s, 1 s to 100 s, 1 s to 10 s, 5 s to 100 s, or 10 s to 100 s. Further, the build rate may be in a range from, for example, 0.1 lb/hr to 1000 lb/hr, 0.1 lb/hr to 500 lb/hr, 0.1 lb/hr to 100 lb/hr, 0.1 lb/hr to 50 lb/hr, 0.1 lb/hr to 10 lb/hr, 0.5 lb/hr to 10 lb/hr, 0.5 lb/hr to 50 lb/hr, 0.5 lb/hr to 100 lb/hr, 1 lb/hr to 10 lb/hr, or 1 lb/hr to 50 lb/hr. Distortion in the deposited component may be affected by amperage, duty cycle required. to hit each deposition rate. Distortion may be reduced or minimized using the non-continuation deposition process, as discussed below in Example 4. Large wire diameters (e.g., 0.045-0.062″) with high amperage and duty cycles (e.g., move speeds in excess of 20-30 m/min) may be capable of achieving high deposition rates while minimizing distortion. Machine X-Y area may not have a large impact on deposition rates compared to travel speeds, but it may affect heated bed requirements and inert gas consumption. Larger machine areas may require higher duty cycles in order to achieve higher deposition rates.

In various embodiments, the welding system 14 can provide an inert shielding gas during the fabrication of the metal component. The inert shielding gas prevents oxidation of the molten metal, which could otherwise create voids, defects, or discontinuities in the final product. Examples of the inert shielding gas include, without limitation, argon, carbon dioxide (CO²), helium, nitrogen, oxygen, and combinations thereof. The welding system 14 can include an inert shielding gas source (e.g., a gas tank) or may be coupled to a central supply if one is available. Multiple techniques may be used to deliver the inert shielding gas, as discussed below, and more than one technique may be used at a time. An example embodiment includes delivery of the inert shielding gas via a GMAW nozzle. The GMAW nozzle produces a laminar flow of inert shielding gas directly above each deposited cell 40 as it is welded. The deposited cell 40 is still red hot as the gas delivery nozzle moves away towards the next deposited cell 40 to be welded, which may still allow oxidation. The deposition method may vary. For example, the GMAW process has multiple modes: short circuit, globular, spray, or pulsed. The short circuit mode results in a low heat input, which could result in faster depositions. The globular mode results in large amounts of spatter. The spray mode has a high heat input, which may eliminate lack of fusion but can result in overheating the component, which may be addressed by techniques discussed further below. In an embodiment, a combination of these modes may be used to build one component depending on the component geometry and requirements.

In another embodiment, the welding system 14 can include delivery of the inert shielding gas via a gas diffusing lens. The gas diffusing lens creates a relatively large area of slow-moving inert shielding gas that displaces oxygen around a portion of the metal component. The diameter of the gas diffusing lens may vary based on, for example, the overall size of the metal component, the average robot move time between deposited cells 40, the raw material used, and the overall temperature of the metal component.

In another embodiment, the fabrication system 10 can include welding the metal component in a bath of the inert shielding gas. The fabrication system 10 can include a chamber having a bottom surface and a sidewall extending up from the bottom surface. In an embodiment, the bottom surface of the chamber may be the welding table 16. The chamber includes an inlet in either the bottom surface or at about the bottom of the sidewall. The inert shielding gas may be delivered to the bottom of the chamber through the inlet. The inert shielding gas, which is heavier than air, displaces the air previously at the bottom of the chamber. As the chamber fills with the inert shielding gas, the air is pushed up and over the sidewall. After the air has been expelled from the chamber, the welding may proceed. In an embodiment, the bath of the inert shielding gas may be used in conjunction with a GMAW nozzle or a gas diffusing lens as described above.

In another embodiment, the fabrication system 10 can include an enclosed inert environment surrounding the metal component as it is being welded. The fabrication system 10 can include a chamber having a bottom surface, a top surface, and a sidewall extending between the bottom surface and the top surface. The interior of the chamber may be filled with the inert shielding gas and pressurized above the ambient barometric pressure. The positive pressure differential with respect to the ambient environment prevents oxygen-rich air from interfering with the welding.

FIG. 4 illustrates an alternative embodiment that includes a plurality of fabrication systems 110 that are each respectively similar to, or the same in many respects as, the fabrication system 10 illustrated in FIGS. 1 and 2. For example, each of the fabrication systems 110 include a frame assembly 112 and a welding system (not shown). However, the frame assemblies 112 can have an overall hexagonal shape that provides for modularity among the fabrication systems 110. As such, two or more of the fabrication systems 110 can fit together in a honeycomb-type arrangement and can cooperate together to fabricate a metal component that is otherwise too large to fabricate using only one of the fabrication systems 110. A hexagonal machine shape allows for a variety of configurations of multiple fabrication systems 110 working in conjunction with one another to linearly scale build area and deposition rate. A scaffolding or support structure (not shown) may be positioned above the modular frame assemblies 112 to provide support for the welding system. The modular fabrication systems 110 may include synchronized or unsynchronized Z-motion.

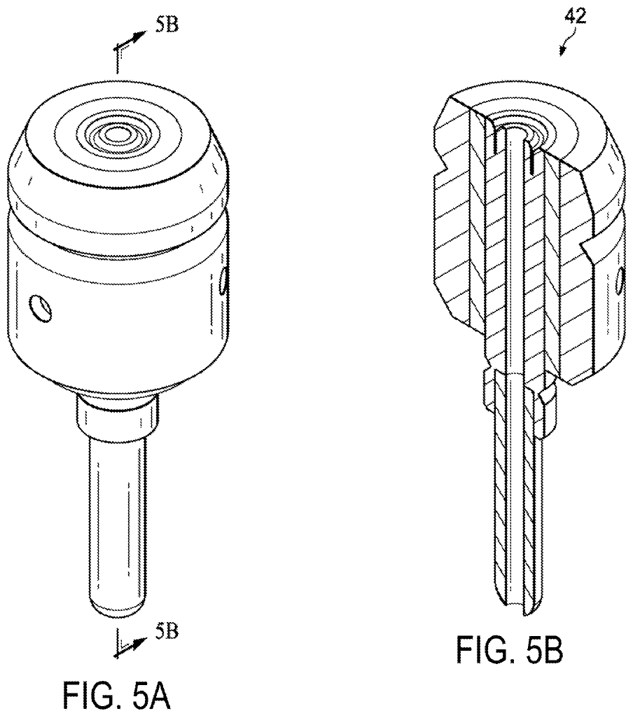

The weld gun 26 may include an end effector designed for the discontinuous deposition architecture as described herein. Traditional welding torches are often too heavy (e.g., in excess of 3 kg) to allow rapid acceleration required for high travel speed of process and do not allow for a simple automated contact tip change during processing. The end effector 42 shown in FIGS. 5A and 5B is designed to weigh less than 1 kg, and can be grabbed with a quick-release collet mechanism for rapid contact tip changes. The welding system may include a carousel of replacement contact tips (not shown) ready to be swapped out as needed. Damage in the event of a machine crash can be mitigated by a notched section located immediately above the contact tip threads. In the event that component temperatures increase the ambient temperature inside the machine significantly, the welding system can include a water-cooled heat exchanger mounted to the exterior of the collet body.

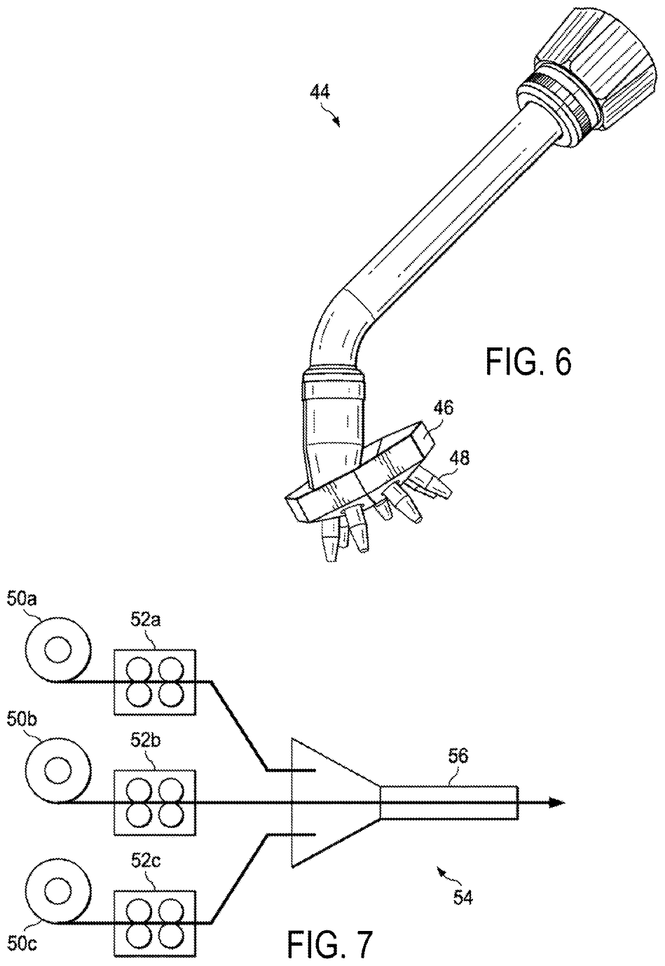

Referring to FIG. 6, an example embodiment of a contact tip exchanger 44 includes a rotating housing 46 holding more than one contact tip 48. In an embodiment, the rotating housing 46 may hold seven contact tips 48. The rotating housing 46 will rotate, or index, to a new contact tip 48 at predetermined intervals. In various embodiments, the predetermined intervals may be based on, for example, the number of deposited cells produced by each tip or a measure of remaining useful life determined elsewhere in the machine. The contact tip exchanger can include a shearing mechanism (not shown) to trim the welding wire as the rotating housing rotates. Accordingly, the trimmed wire remaining in the current contact tip rotates away from the welding wire extending from the welding wire source (e.g., spool or container). The free end of the welding wire is then fed through the new contact tip after the rotating housing has finished rotating. The contact tip exchanger 44 increases the run time of the welding machine 22 without intervention.

In an embodiment, the welding machine 22 may include a multi-tip end effector. In an embodiment, the end effector may include three tips. The triple-tip end effector can include three welding contact tips positioned along the perimeter of a circle, spaced at 120 degrees apart such that each contact tip is able to produce a deposited cell within the sorting pattern at the same time within one robot movement. In another embodiment, the multi-tip end effector could be used in a multi-material configuration in which each contact tip on the end effector could hold a welding wire of a different material.

In some embodiments, multi-material components can be produced by integrating multiple wires into a single system. For example, the welding system 14 may include a single end effector capable of producing deposited cells from welding wire extending from more than one wire feeder. Referring to FIG. 7, in an embodiment including three separate material sources 50a, 50b, 50c, three feeders 52a, 52b, 52c may be used. The welding wire extending from each feeder 52a, 52b, 52c extends into a guide 54. The guide 54 may be, for example, shaped like a funnel and may be metallic. The first welding wire to be used is fed through the neck 56 of the guide 54 and out of the end effector. To change materials, the first welding wire is retracted from the neck 56 of the guide 54, and the welding wire of the desired material is fed through the neck 56 and out of the end effector.

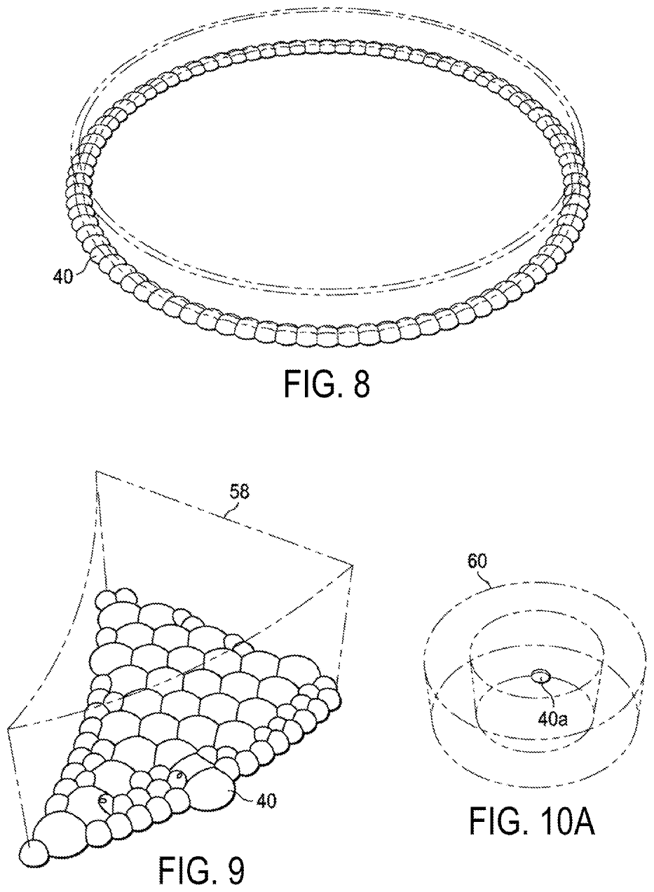

The deposited cells 40 deposited on the weld plate 38 can be provided in the pattern illustrated. in FIG. 3 using non-continuous deposition. To achieve this pattern, a first layer of deposited cells 40 can first be disposed on the weld plate in a matrix-type arrangement where each deposited cell 40 is spaced substantially equidistant from adjacent deposited cells 40. Each subsequent layer of deposited cells 40 that is added can be deposited in a similar manner relative to the underlying layer until the metal component is formed. In an embodiment, the matrix-type arrangement of each layer is a hexagonal grid. In another embodiment, as shown in FIG. 8, a layer can have deposited cells 40 that are not arranged in a matrix or grid. Such a layer may be used, for example, where thin walls or portions of a component exist. In another embodiment, as shown in FIG. 9, the deposited cells 40 could be arranged with some flexibility in the overlap of adjacent deposited cells 40, or the diameter of the deposited cells 40 to more closely match the net shape of the component 58 or help optimize some aspect of component formation. In one embodiment, a portion of the welding table 16 disposed beneath the weld plate 38 can be selectively retracted towards the lower shelf 18 to accommodate larger metal components. Further, the welding table 16 or the articulated robot 26 may be configured to move down or up, respectively, to allow more room for the welding process after each layer is completed.

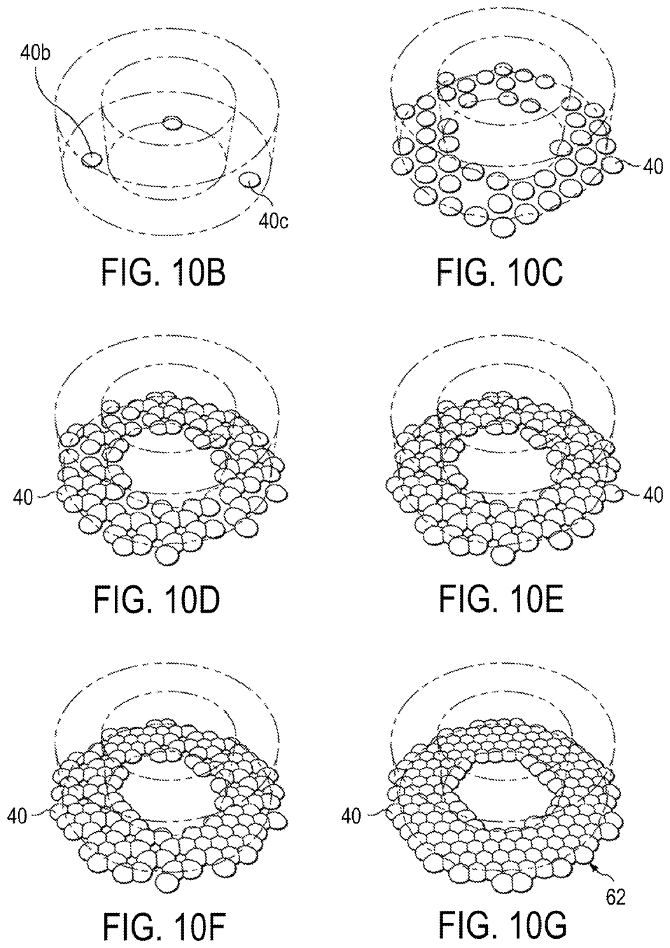

FIGS. 10A-10G show an example deposition process for a layer of a component. The hollow cylinder 60 represents the component to be built. FIG. 10A shows a first deposited cell 40a. In FIG. 10B, a second deposited cell 40b and third deposited cell 40c have been deposited in a non-continuous manner. Each of deposited cells 40a,b,c are spaced apart from each other. FIG. 10C shows additional deposited cells 40 deposited, where each deposited cell 40 remains separate from the other deposited cells 40. As more deposited. cells 40 are deposited, the deposited cells 40 become interconnected in a hexagonal array. At first, the array may be of ‘hollow’ hexagons (e.g., parts of FIGS. 10C and 10D). As the deposition continues, the centers of the ‘hollow’ hexagons are filled (FIGS. 10D-10G). FIG. 10G shows a completed first layer of deposited cells 40. As can be seen, some deposited cells 40 extend beyond the boundary of the modeled hollow cylinder. To complete the component, additional layers would be deposited on the first layer. In an embodiment where the component is a blank for a part; the component can be post-processed to remove the excess material and reveal the shape of the part (e.g., hollow cylinder 60).

The shape and dimensions of each deposited cell 40 may vary. In an embodiment, the shape of the deposited cells 40 may be generally shaped like a cylinder, clipped sphere, hemisphere, or any other suitable shape. In various embodiments, the average diameter of each deposited cell may be in a range of 0.1 mm to 50 mm, 1 mm to 45 mm, 1 mm to 30 mm, 1 mm to 20 mm, 4 mm to 16 mm, 5 mm to 20 mm, 10 mm to 30 mm, 10 mm to 40 mm, 10 mm to 50 mm, 20 mm to 50 mm, 30 mm to 50 mm, or 40 mm to 50 mm. In some embodiments, the average height of each deposited cell may be in a range of 0.1 mm to 25 mm, 0.1 mm to 20 mm, 0.1 mm to 10 mm, 0.1 to 5 mm, 0.5 mm to 5 mm, 0.5 mm to 10 mm, 0.5 mm to 20 mm, 1 mm to 4 mm, 1 mm to 5 mm, 1 mm to 1.0 mm, 1 mm to 20 mm, 5 mm to 10 mm, 5 mm to 20 mm, 5 mm to 25 mm, 10 mm to 20 mm, or 10 mm to 25 mm. In various embodiments, the diameter to height aspect ratio may vary and may be, for example, at least 1, at least 1.5, at least 2, at least 2.5, at least 3, and at least 5. These shapes and ranges may also apply to the cells in the cellular model.

In an embodiment, the deposited cells 40 may overlap adjacent deposited cells 40. The overlap of a single deposited cell 40 may be based on the percentage of volume that overlaps with any adjacent deposited cell 40. The overlap may be in a range of 0% to 50%, 0% to 40%, 0% to 30%, 10% to 50%, 10% to 40%, 10% to 30%, 20% to 50%, 20% to 40%, or 30% to 50%. In an embodiment, the overlap can be 20%. In some embodiments, there may be a tolerance of +1-10% of the overlap for the deposited cells 40. In another embodiment, the overlap between the deposited cells 40 is based upon the distance by which adjacent deposited. cells 40 overlap. This overlap may be in the range of 0% to 50%, 0% to 40%, 0% to 30%, 10% to 50%, 10% to 40%, 10% to 30%, 20% to 50%, 20% to 40%, or 30% to 50% of the radius of the deposited cell 40. In some embodiments, there may be a tolerance of +/−10% for the relative distance of the overlap to the deposited cell radius. These ranges and tolerance may also apply to the cells in the cellular model. It will be appreciated that any suitable overlap is contemplated that reduces cavities in the finished component or otherwise improves the consistency or integrity of the component.

In an embodiment, the size of each deposited cell 40 may be the same. In another embodiment, the deposited cells 40 may have variable sizes. For example, deposited cells 40 at the edge of a layer may be smaller in size than those not adjacent to the edge. FIG. 9 shows an example layer of deposited cells 40 including multiple deposited cell sizes and a non-uniform pattern. In the embodiment shown in FIG. 9, the varying sizes and pattern of the deposited cells 40 is based on circle packing techniques and may vary to optimize the amount of material used, surface finish, deposition rate, or a combination thereof. Cell size and shape may vary cell-to-cell, by layer, by position relative to an axis or center point, or for any other suitable reason.

The edges of each layer may include an overhang or a portion of one or more deposited cells 40 that is unsupported by the layer directly below. An overhang degree may be measured between a line or vector normal direction of the substrate or a lower layer of the component and a vector tangent to the lower leading edge of the overhanging portion of the cell. The overhang degree may be in a range of, for example, 0° to 90°, 0° to 75°, 0° to 60°, 0° to 45°, or 0° to 30°.

Suitable metals include, without limitation, iron, nickel, titanium, copper, aluminum, steel, and alloys, such as stainless steel, austenitic, ferritic, martensitic, precipitation hardening alloys, iron alloys, nickel alloys (e.g., Inconel®), aluminum alloys, copper alloys, and titanium alloys. In one embodiment, each of the deposited cells 40 can be formed of the same material (e.g., welding wire), such that the component is a homogeneous component. In another embodiment, certain of the deposited cells 40 can be formed of a different material such that the metal component can be heterogeneous (e.g., an aluminum component having a portion of steel embedded therein). It is to be appreciated that each particular layer of deposited cells 40 deposited on the weld plate 38 does not need to be completed before depositing additional deposited cells 40 over that layer. The embodiments described herein are not limited to metal components, as discussed further below. Homogenous components can include a center portion having one composition with an outer coating having a different composition, pockets of the component having different compositions, layers of the component having different compositions, or the like.

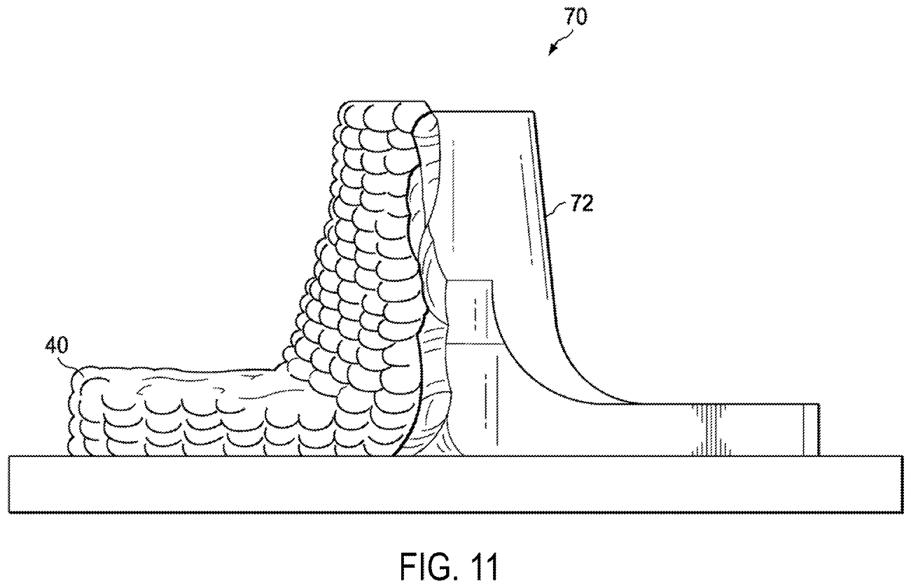

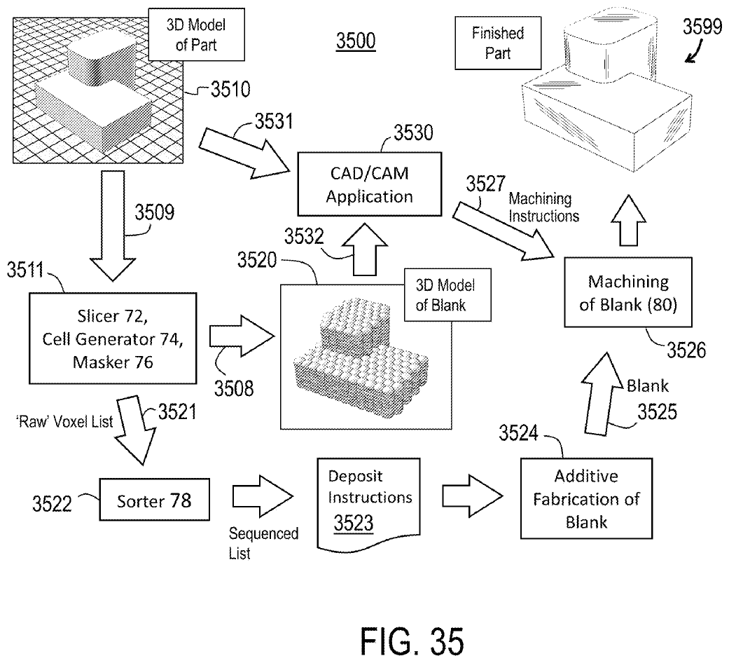

Machining a blank formed in accordance with methods described herein can allow for less material that needs to be removed during the milling process, which can lead to significant time and cost savings during manufacturing, while also reducing complexity of the overall additive manufacturing system. As shown in FIG. 11, a blank 70 is shown as built using a non-continuous deposition process as described. herein. The blank 70 is shown with portion 72 that has been machined to reveal the shape of the final part. Providing blanks in accordance with embodiments described herein can approximate the shape of a finished part, such that less machining in required, while eliminating or reducing the need for highly granular and complex additive manufacturing systems. In an embodiment, less than 30% of the volume of the blank is removed during machining. In other embodiments, the volume of the blank removed during machining can be in a range of 5% to 40%, 5% to 30%, 5% to 20%, 10% to 40%, 10% to 30%, 15% to 40%, 15% to 30%, or 20% to 40%. In accordance with embodiments described herein, considerable savings can be made even with fairly small components and inexpensive materials. The cost savings grow exponentially with respect to starting billet volume. In addition, using a deposited cell-by-deposited cell, layer-by-layer process can allow for a robot arm having three or four degrees of freedom to be used instead of more complicated and expensive six-degree and seven-degree of freedom robots typically used in conventional metal additive manufacturing processes. An advantageous manner for providing an ‘as-deposited’ model of the blank to a subsequent process that calculates machining tool paths is presented in FIG. 35.

One example of a method for manufacturing a component will now be discussed. First, a computer model of a final part is provided to the controller 36, which identifies the overall shape and size of the metal component that should be fabricated to ensure the final part can be milled or otherwise processed therefrom. The controller 36 can then calculate the optimal deposition order and pattern of the deposited cells 40 to be deposited on the weld plate 38 (e.g., based on heuristics or other conditions such as those discussed further below). The weld plate 38 can be oriented on the welding table 16 and locked in place (e.g., with clamps). The controller 36 can establish a datum (e.g., reference frame) on the substrate 38 which can be a corner or other physical feature. The controller 36 can then operate the welding machine 22 and the articulated robot 26 to begin depositing deposited cells 40 on the weld plate 38 using the datum as a reference frame. During deposition of the deposited cells 40, the controller 36 can monitor various operating characteristics of the welding system 14, such as the voltage and current input at the weld gun 24, for abnormalities that may be indicative of an imperfection in the metal component. If an abnormality is detected, the location of the abnormality (e.g., the deposited cell location) in the component can be flagged for further investigation by the user. Once fabrication of the component is complete, the weld plate 38 can be removed from the welding table 16 and the component can be subsequently milled or otherwise finalized. For example, the post-process machining of a blank may be handled by a CNC milling or turning machine. The datum identified by the controller 36 can be used during the milling process to identify the metal component on the weld plate 38 more easily than with conventional datums (i.e., datums that are integrated into the component itself) which can save significant time and cost. It will be appreciated, however, that systems described herein can be used to manufacture completed parts. For example, components not requiring tight tolerances or a highly specific configuration can be made using embodiments described herein without post-processing or machining. In one embodiment, portions of a component may be machined while other portions of the component may not be finished or otherwise altered.

In various embodiments, multiple components may be constructed in the same deposition process. For example, more than one component may be built in parallel or series, and each component may be built with reference to a single datum. In an embodiment, more than one of the same can be built in parallel or series. In another embodiment, more than one component of different types can be built in parallel or series. As discussed above, each component can be built from a datum or chosen reference point. The build order can then be sorted out to be parallel or series production, after which the cell arrays are sorted. More than one articulated robot 26 may be used.

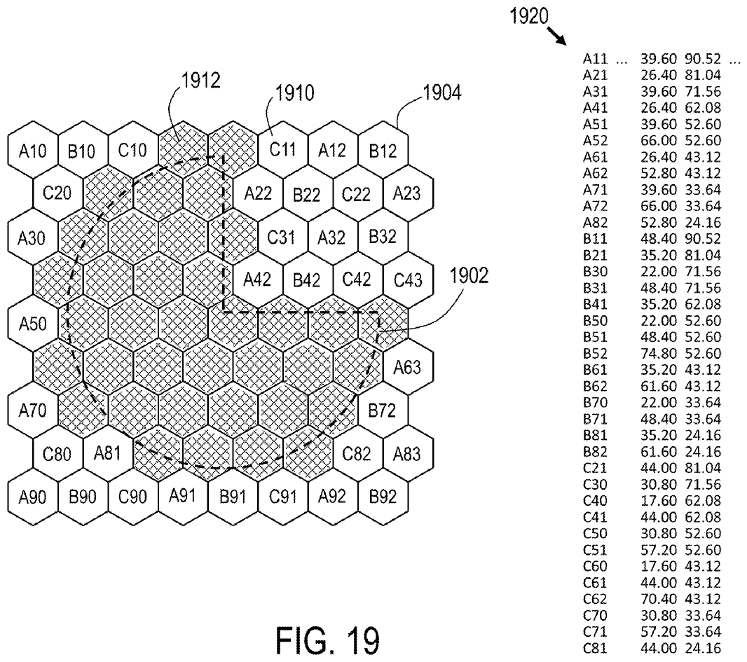

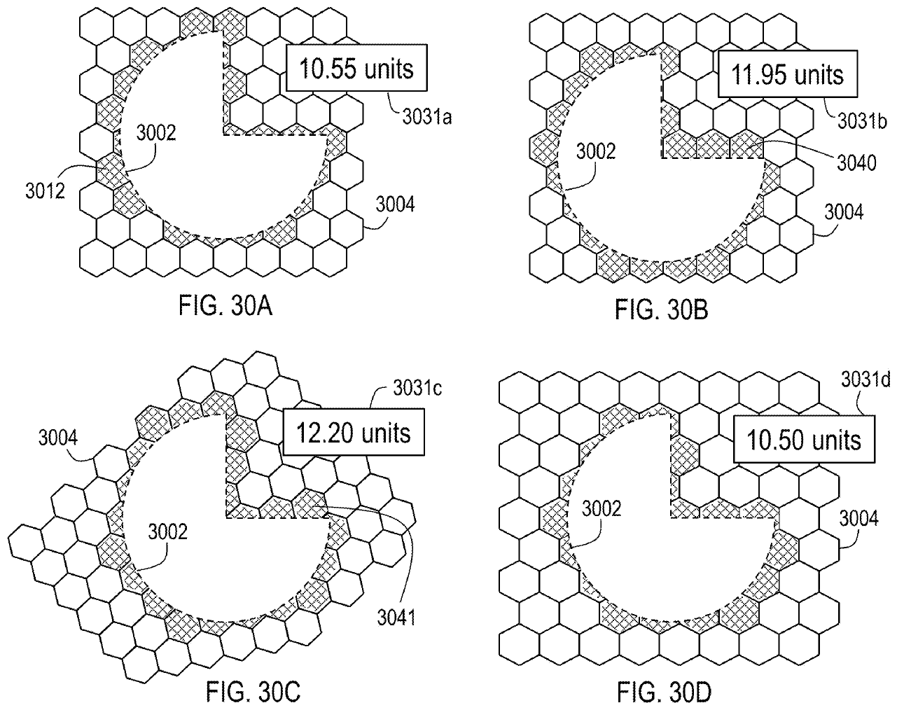

An example embodiment of software used in the additive manufacturing processes described above includes manipulation of a computer model of the component to be built. A boundary representations (b-rep) model is brought into a build preparation software. The software can then assist the user to quickly orient that model in the machine and plan how the component will be created. The user then chooses a predefined parameter set for the build. The parameters that may be defined include, but are not limited to, layer height, cell height, cell diameter or width, cell aspect ratio, arc on time, wire feed speed, stick out distance, voltage, maximum interpass temperature, overlap distance, overlap percent, deposition time, retraction distance, X-Y-Z positions, i-j-k tool axis vector components and supply or machine characteristics such as program number (a power supply dependent value), arc control (power supply dependent value), work offset (reference frame for the robot), etc. To create the discrete depositions from the component or part model, the software first builds a series of planes separated by the layer height given in the parameter set, and then finds the intersections of each of these planes with the part model. Each of these layers is then covered with an array of cells, such as those described above. In an embodiment, the array is a rectangular array of hexagonally spaced cylindrical cells. Each cell is then checked to determine whether or not to include it in the model. In an embodiment, the program determines what cells are entirely contained within the boundary of the layer. Cells that are contained entirely by the layer contours are included in the model. Next, for any cells not contained entirely by the contours of the layers, the program can determine whether the boundary of the cell intersects the boundary of the layer. The cells having boundaries that don't intersect the layer boundary are not included in the model. For the remaining intersecting cells, the program can determine whether the surrounding cells already cover all of the area of the layer boundary. If a cell is needed to completely cover the area of the layer boundary, that cell is included in the model otherwise it is not included. This process occurs for each layer. (These aspects will be further described in conjunction with FIG. 19 and FIG. 30 below.)

In one alternative embodiment, the discrete depositions are populated through a 2D packing algorithm, rather than being created with an underlying grid. After establishing the intersection curve for each layer, the curves are then filled with uniform sized cells (e.g., cylindrically shaped). The cells may have a defined overlap and an optional programmable tolerance (e.g., +1-10%). Alternatively, in another embodiment, the boundary is filled with circles having a varying diameter with a defined overlap. In another embodiment, the diameter and/or the overlap may vary according to a determined relationship.

In another embodiment, the software does not divide the model into a series of planes, and instead the user selects a starting surface and the contours of the model are filled using a 3D cell packing algorithm. This algorithm can start by building up cells with tool axes built according to the given surface or surfaces. Then additional layers would be created based upon the previous deposition surface or surfaces. This process can repeat until the volume was filled and could be iterated on to optimize packing according to a given metric such as minimizing wasted volume, minimized deviation in overlaps, etc.

The cells can then be rendered, and the user can then preview the initial model superimposed. with the planned discrete deposited cells. If the user desires more stock added they can then add an extra padding layer of depositions around the edges, and the model rendered again. Next, the depositions are then sorted as discussed above and passed along to the machine. The user can then choose to export the cellular model (e.g., as a mesh or NURB model) to the CAD or CAM package of their choice for post-process machining and create a build file for the machine. Examples of the software and techniques utilized by the controller 36 are discussed further below. Additionally, an advantageous manner for providing an ‘as-deposited’ model of the blank to a subsequent process that calculates machining tool paths is presented in FIG. 35.

The process for creating the cell-based architecture can happen very quickly. First, the math for adding offsets or adjusting overhangs is simplified from complicated geometry used in traditional additive or CAD/CAM systems (e.g., where the boundary curves or the actual model geometry needs to be offset and modified and all of the edge cases need to be addressed) to modifying 1D or 2D bitmasks based on whether or not a cell is within the boundary of a layer, as discussed above. This significant simplification of the planning speeds up the processing dramatically. Next, because each cell can essentially be treated as its own unit, the system can include complete traceability from start-to-finish of each cell within the model. In addition to traceability throughout the build, it also allows for the cells to be the finite elements in the analyses to allow for easier prediction of the results and close the control loop to get the component built correctly the first time. Finally, this simplified model can be passed directly to a CAD or CAM package for post-process machining in any software of choice. This is a simpler, streamlined system that not only removes significant complexity from the conventional process but also enables the user to make better components with less effort. In an embodiment, the system includes machine learning in conjunction with a data acquisition (DAQ) system to improve the processing, such as where data regarding minimizing voids can be used to optimize cell deposition.

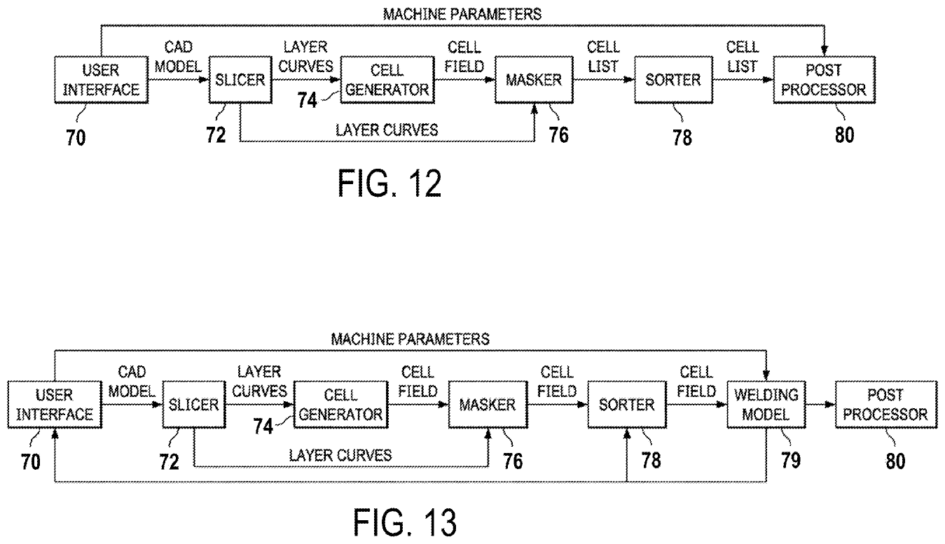

FIGS. 12 and 13 depict example embodiments of the high level software architecture that can be used. The user interface 70 may be in an existing system (e.g., an existing CAD or CAM platform, such as Rhinoceros®) and allows the user to pick a parameter set from a predetermined list. In one embodiment, these parameters can be stored in an INI or csv file. The software may be configured for creating, testing, and managing parameter sets. The software can also be configured for version control. In an embodiment, the user may be able to select a bottom face allowing the component to be set up with respect to a known machine datum automatically. The software can check the extents and provide feedback to the user about the current orientation.

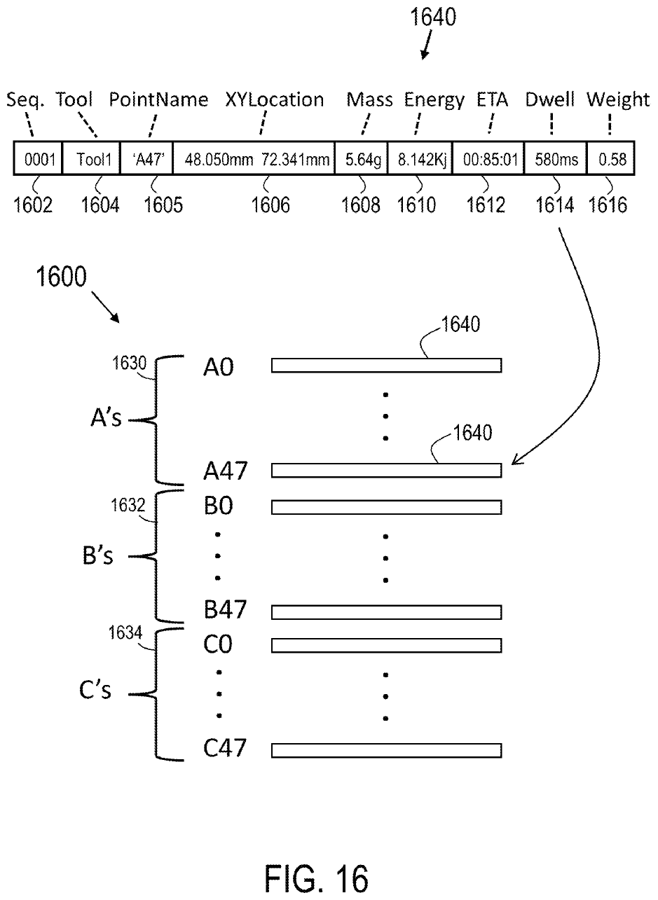

The slicer 72 receives the incoming geometry and the given layer height and builds an array of planes through the object layer height away from each other in the Z-direction. It then intersects the model with the planes and creates a series of layers or ‘model layer slices.’ Each layer is a group of curves or ‘contours’ on the same plane where the model intersects the plane. These layer curves are passed both to the cell generator 74 as well as the masker object upstream. Once the layer curves are generated, then each layer is passed to the cell generator 74 where a bounding box is generated for the layer and a cell field is generated over the bounding box, and it is extended several multiples of the cell diameter over each edge. The field is represented as, for example, a ID bitmask array with stored dimensions or as a 2D bitmask in so-called ‘raster’ arrangement. (A one-dimensional listing of records, each comprising two-dimensional coordinates, is shown in FIG. 16.)

The masker 76 takes the layer curves as well as the bitmask array and creates an equal length ID bitmask. It then populates the bitmask based on what cells will be used to form the layer, as discussed. above, to create the final hit mask array. In an embodiment, the software then checks for intersection to keep cells if the intersecting length is above a predetermined threshold. The user could guide this setup through the GUI. It can also create a bit mask for rendering where the interior volume is removed for a lightweight version. In an embodiment, the cell fields are created as a grid along the X- and Y-axes. The software can be configured to allow the user to manually shift the edges for extruded objects. In an embodiment, the software may be configured to align the cell grid so that it uses the smallest feasible number of cells for a given layer. In another embodiment, the software may be configured to allow for multiple cell sizes and/or non-grid creation by using some circle packing of the layer curves. In some embodiments, the software can be configured to minimize the overhangs by reducing the angle or extrude the furthest overhanging portions down to the build plate. (Processes for manually or automatically making such adjustments are shown and described in connection with FIGS. 30-32.)

Conventional slicers typically work by intersecting a model with a surface at one point and calling that a layer essentially by extruding that layer up or down. One potential issue with this method is that it can miss any Z feature less than a single layer height. As the layer height increases, this can rapidly cause issues especially if the goal is to always make a stock positive component. To overcome this, in an embodiment, the software is configured to take multiple slices per layer and take the largest version of the superimposed. curves to create a more accurate boundary for the layer. In an embodiment, the software treats one cell as one discrete deposition (e.g., one deposited cell 40).

Still referring to FIGS. 12 and 13, the sorter 78 is a sorting object that takes the cell field and converts it into a sorted ID array of cells. In an embodiment, the cell sorting is a multi-stage system where the field is first divided into three segments in which no cells are directly adjacent (unless there too few cells in a given layer), after which each segment is randomized or sorted, as described below, and then recombined into a single list of cells to be generated within the machine. The number of segments may vary. There may be adjacent, continuous depositions in a layer where there are three or fewer discrete depositions.

The post processor 80 can take a list of cell objects and convert it into commands that are readable by a machine, such as a welding robot. Notably, this may be the only step of the process that may be specific to the type of machine being used. Primarily, it provides the structure for a program and configures and moves through each cell in the list and applies the discrete deposition. In an embodiment, a deposition model, such as welding model 79 can be generated and provided to the post processor 80.

As discussed earlier, the sorting process can be based upon a stack of heuristics. In this system a series of heuristics could be applied to the cell field in which a heuristic gives each cell a weighting factor. The weighting factors for each heuristic are combined per cell, and the system can select the next cell to be deposited by finding the maximum or minimum value depending upon the weighting factors' sense. In this way, the sorting could take into account multiple factors such as, minimized distortion, maximized build rate, minimized thermal input, net cooling rates, maximum interpass temperature, etc., but also be flexible as the component is being built (e.g., as the temperature changes). Additionally, the software can provide a STEP, STL, or other solid output file that can then be used in later stages of processing. An advantageous manner for providing an ‘as-deposited’ model of the blank to a subsequent process that calculates machining tool paths is presented in FIG. 35.

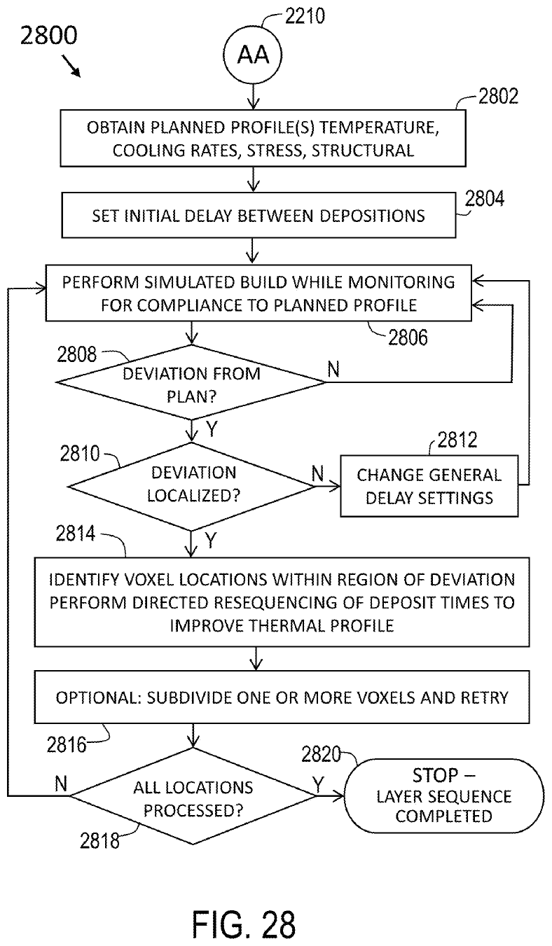

In an embodiment, the system may employ an algorithm or model to predict physical characteristics of the deposited cells and/or the component as a whole. Such physical characteristics include, without limitation, stress, strain, deformation, temperature, deposited cell thermal history, etc. The model can be a finite element analysis model based on the cellular mesh of the component to be produced. Each deposited. cell can have an associated heat input based on processing parameters (e.g., voltage, amperage, and arc-on time). The thermal history of the completed component can be predicted by the model based on the order in which cells are sorted and produced within the slicing software. The data from the thermal model can be used to predict thermal strains and residual stresses within the completed component by using the same finite element analysis system. A process for predicting behavior and performing simulations and then making responsive adjustments to build instructions is set forth in FIG. 28.

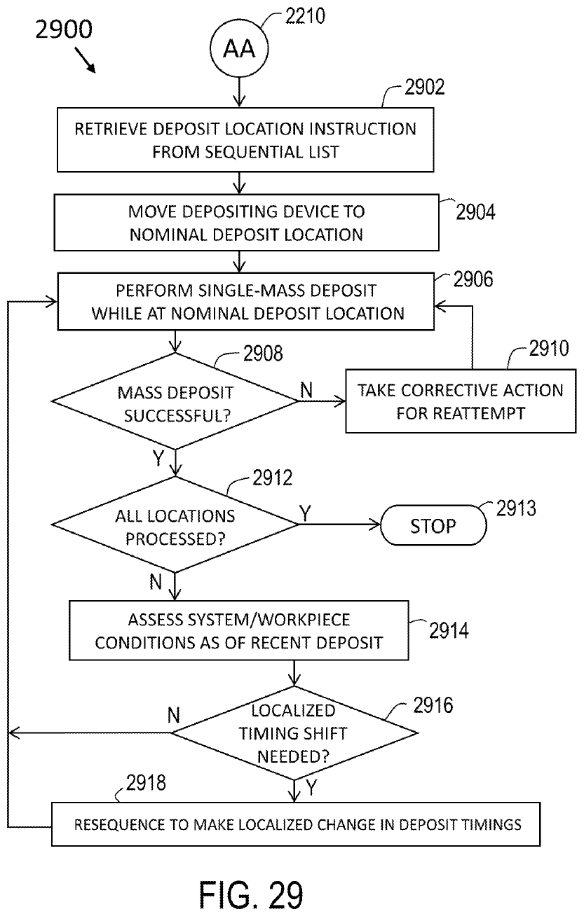

In various embodiments, the software may be configured to display the expected material properties of the component and/or how long the component will take to build using the chosen parameter set. For example, as discussed above, a model may be used to predict physical characteristics (e.g., in a plot or profile format), which may inform the user in making adjustments to the sorting. Due to the size and organization of the cells, the microstructure of the entire deposited structure (with the exception of the outer surface of the final component) could be controlled by modifying the parameters used to generate each cell. In an embodiment, the software can allow the user to adjust the parameters after the initial cellular mesh is created. This allows the user to iterate with various parameter choices to produce a component that best meets the desired material characteristics. In an embodiment, the discrete deposition process could control the tempering effect on alloy and high carbon steels in order to mitigate crack susceptibility commonly seen in other AM processes. Adjusting the cell generation parameters could also be used to control precipitation reactions in other alloys. The software can be configured to take the generated planes and do as much of the processing from planes to masked cell fields in separate threads or processes to optimize the speed. In an embodiment, the time frame for the software to process and slice a model is less than 0.1 s, which allows the system to be recalculating cell sequences according to data being collected during the build process. At least one process for performing such adjustments is explained in the context of FIG. 29.

In an embodiment, each cell is traceable. Each cell has a number of associated parameters. For example, the history of what user created the planned cell and when may be stored. The associated parameters can also include what machine was used to build the cell (i.e., perform the discrete deposition to create the deposited cell(s) 40), the time and date of deposition, feedback from any sensors, and comparison with the predictions about that cell. Thus, the system may be able to predict and track defects throughout and tie them back to their root causes.

In an embodiment, process data may be collected and stored. Process data, such as amperage, voltage, and wire feed speed, can be easily captured by using standard welding equipment. This data can be used to continuously monitor cell quality and build a digital twin of the component, which can be used both to reduce non-destructive evaluation (NDE) requirements and as an aid for post-process machining Data collection will also enable closed-loop control of the process to further increase performance and reliability.

As discussed above, the particular order in which the deposited cells 40 are deposited onto the weld plate 38 can be selected (e.g., sorted) based upon any of a variety of desired heuristics or other conditions. In an embodiment, the order of deposition can be selected to ensure that each deposited cell 40 is never placed next to the deposited cell 40 that was deposited last except where there are too few discrete depositions per layer. In another embodiment, stacked heuristics may be used to give preference to next deposited cells 40 that have a larger distance (or an ‘ideal’ distance given machine speed and necessary cooling delays) from the previous deposited cell 40. In yet another embodiment, the order of deposition can be selected to achieve a desired build speed for the metal component (e.g., maximum speed).

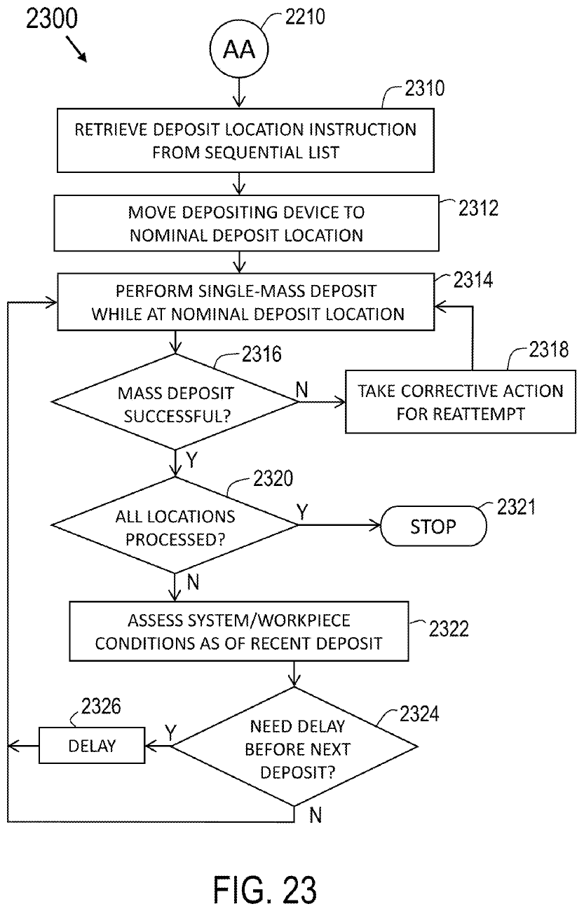

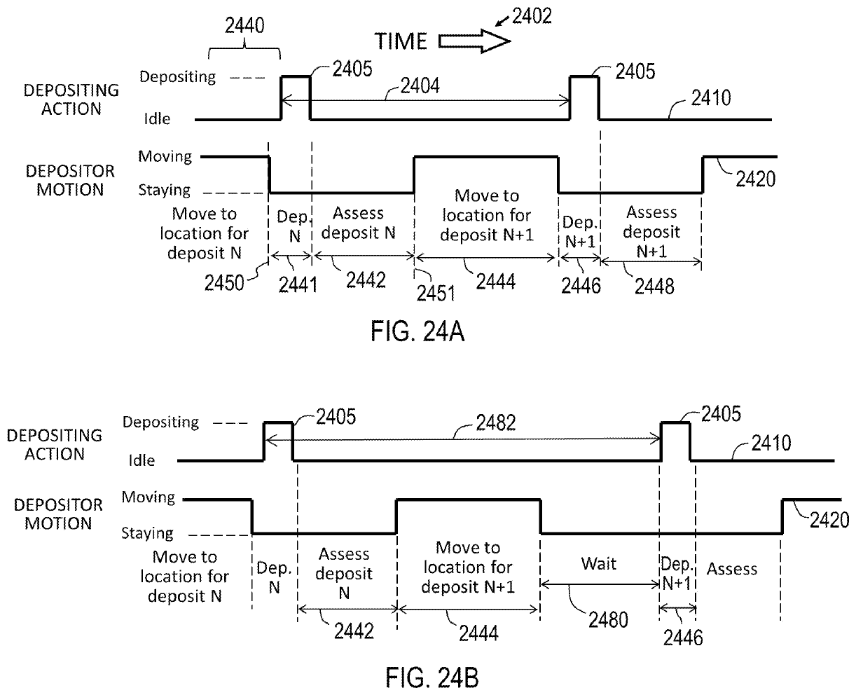

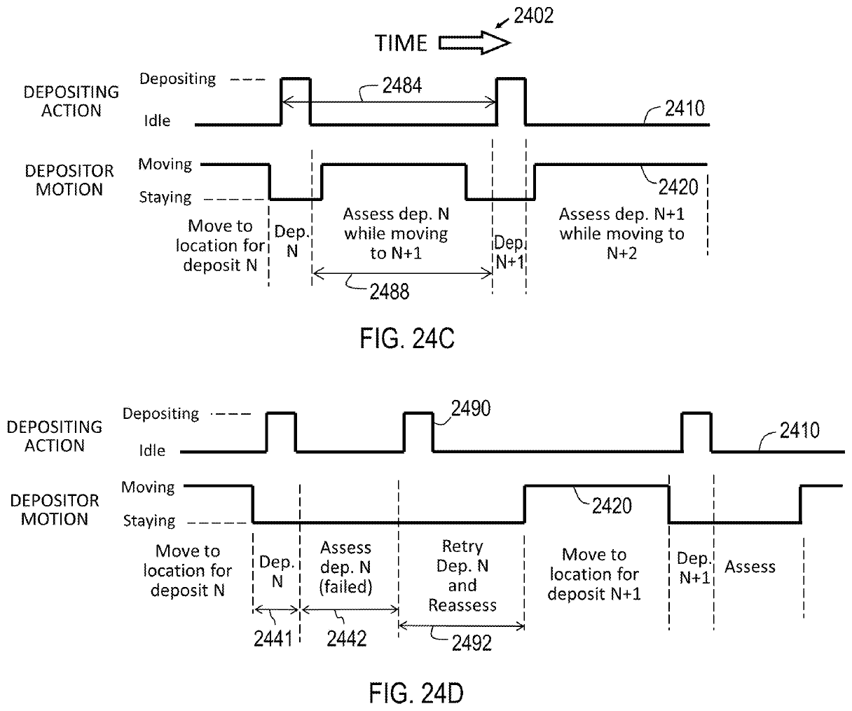

In one embodiment, the timing and/or order of deposition can be based upon a profile of physical characteristics of the metal component being manufactured. In such an embodiment, the timing and/or order of deposition can be selected to ensure that each deposited cell 40 is deposited in an area that is cool enough to receive the deposited cell 40. To that end, in some embodiments, the interpass temperature (i.e., temperature of the metal component prior to an additional deposited cell being welded to the metal component) can be controlled based on, for example, the timing of each weld or the order of deposition. Control of the interpass temperature affects the desired geometric shape and material properties of the metal component. Multiple techniques may be used to control the interpass temperature, as discussed below, and more than one technique may be used at a time. In an embodiment, the fabrication process includes a time-based delay between welding of each deposited cells 40. For example, the deposited cells 40 may be applied periodically. The time-based delay may be based on, for example, the interplay between the cross-sectional area of the sliced. component in the current deposition surface (e.g., the surface area of the layer currently being deposited, in mm²), the temperature of the metal component (e.g., measured or predicted in ° C.), and a delay time (e.g., in seconds). As the cross-sectional area decreases, the temperature of the component was observed to increase. Delaying the welding of the next deposited cell 40 reduces the overall heat input and, consequently, the temperature of the metal component. Smaller cross-sectional areas may require longer delays between each weld. The time-based delay between the welding of each deposited cell 40 may be on the order of seconds. For example, the delay between each weld may be on the order of seconds in the single digits. The length of the delay may be constant or may vary over time. In an embodiment, the length of the time delay can vary based on changing characteristics of the component as it is built. For example, the length of the time delay can be adjusted based on changes in component temperature, the cross-sectional area of the current layer being deposited, energy input associated with the deposition parameters of each deposited cell 40. FIGS. 23 and 24A-24D elaborate on the control of delays between deposit events, such as single-mass transfer events.

In some embodiments, a predictive algorithm or model, such as one discussed above, may be used to determine or adjust the deposition order and timing. Using such an algorithm or model, the sorting and. timing of the deposition of each deposited cell 40 may be determined or adjusted to reach a goal, such as minimizing thermal gradients throughout the component, maintaining a certain cooling rate, reducing or evening out residual stress, or producing maximum overhang. The algorithm or model may be adjusted based on feedback of the build process. A process for such adjustments is explained in connection with FIG. 28.

In another embodiment, the timing and/or order of depositions can be controlled based on feedback from the welding system 14. For example, the welding system 14 may include a temperature sensing device associated with the controller 36. The temperature sensing device may be, for example, coupled to the weld gun 24 or the articulated robot 26. Examples of the temperature sensing device include, without limitation, an optical pyrometer, an infrared (IR) thermometer, etc. The temperature sensing device is configured to measure the temperature of the welding pool. The user may define a maximum interpass temperature. The maximum interpass temperature may vary and, in some embodiments, may be in a range of 0° C. to 2000° C., 0° C. to 1000° C., 0° C. to 500° C., 0° C. to 100° C., 100° C. to 500 ° C., 100° C. to 1000° C., 100° C. to 2000° C., 200° C. to 500° C., 200° C. to 1000° C., or 200° C. to 2000° C. When the weld gun 24 is moved to the next position, controller 36 receives the newly measured temperature form the temperature sensing device. If the temperature is below the maximum interpass temperature, the weld gun 24 can weld the next deposited cell 40. If the measured temperature is above the maximum interpass temperature, the system may perform one of two operations. First, the controller 36 may delay the next weld until the measured temperature is below the maximum interpass temperature. Second, the controller 36 may move on to the next planned cell in the program, with the intent of returning to the skipped cell at a later time, which allows the portion of the metal component that is too hot to cool down prior to welding the skipped cell. Thus, because any delay between welding the deposited cells 40 is based on temperature, the time between each weld may vary (e.g., not be periodic). (FIG. 29 provides an example process for the above features. FIGS. 24A-24D further depict, and explain control of, delay intervals.)

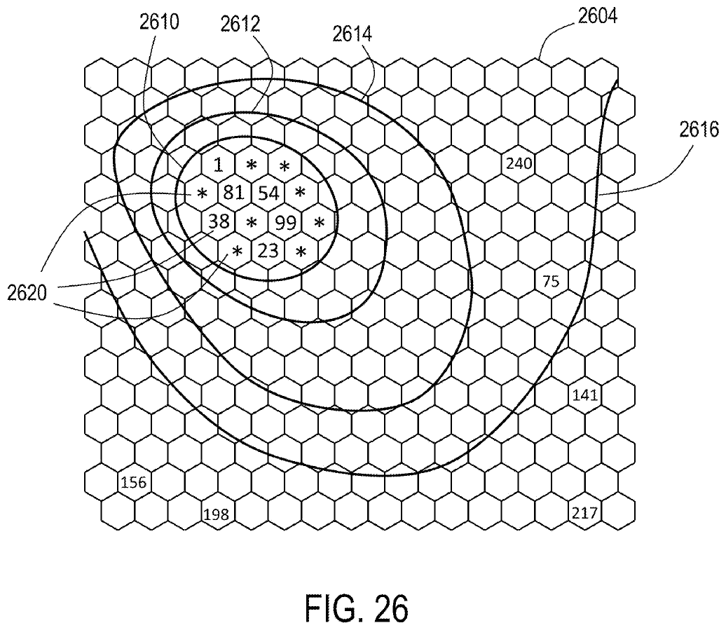

In another embodiment, the temperature sensing device may include a thermal imaging camera. The thermal imaging camera can be configured to measure the temperature of a relatively larger portion (e.g., compared to an optical pyrometer) or the entirety of the metal component. The controller 36 may be configured to determine whether the temperature of the area intended for the next deposited cell 40 is above or below the maximum interpass temperature as discussed above. Additionally, because the temperature of a larger portion of the metal component is being analyzed, the controller 36 may be configured to measure and analyze localized thermal trends. The thermal trends may affect the order of the upcoming welds. If, for example, the controller 36 sees that the area for an upcoming weld is above the maximum interpass temperature, the controller 36 may proactively move to the next weld that has a temperature below the maximum interpass temperature. (Refer to FIGS. 26, 27 and 29 for more details.)

While the above embodiments are described in a welding application, the technology is not so limited. The benefits of simplifying programming, reducing thermal stresses and distortion, and reducing personnel/operating costs apply across many applications. The embodiments as described above may be applied in additive manufacturing applications such as laser/powder directed energy deposition, laser/wire directed energy deposition, laser powder bed fusion, binder jetting, cold spray, or a combination thereof. While the embodiments as described above are directed to metal materials, the materials useful in the embodiments can include, without limitation, metals, alloys, ceramics, plastics, composites, glass, and a combination thereof. Further, these techniques may be applicable in painting, repair, and other robotic sorting applications.

A three-dimensional space may conceptually be subdivided into an array of finite-sized. elements of volume called ‘voxels’ that each have a particular location and bounds within the three-dimensional space, in much the same way that a two-dimensional raster image may be subdivided into ‘pixels’ that are indexed or arranged by row and column.

As used herein the term single-mass transfer' refers to a depositing of material, either onto a substrate or upon previously deposited materials, as a consolidated single mass. A single-mass transfer event will generally correspond to a single instance of energizing the given mass of feedstock material as the mass becomes integral to the ‘workpiece’ or part being formed through an additive process.

In accordance with preferred embodiments of the present teachings, each instance of a single-mass transfer will entirely or substantially fill a voxel space having planned boundaries in XY and depth in Z. In general, as an object is constructed from approximately planar layers of deposited material, each voxel to be filled will have a height equal to a layer height which is also the vertical increment by which the movement of the depositor(s) will be placed further away from a build surface as one layer is completed and a next layer is to be commenced.

Thus, in the course of build a layer of material, a deposition performed by single-mass transfer preferably creates, in a single momentary emission as a consolidated mass, a deposit of material that fills the voxel to the designated layer height. Preferably, therefore, a build layer is formed from a monolayer of adjoining material deposits.

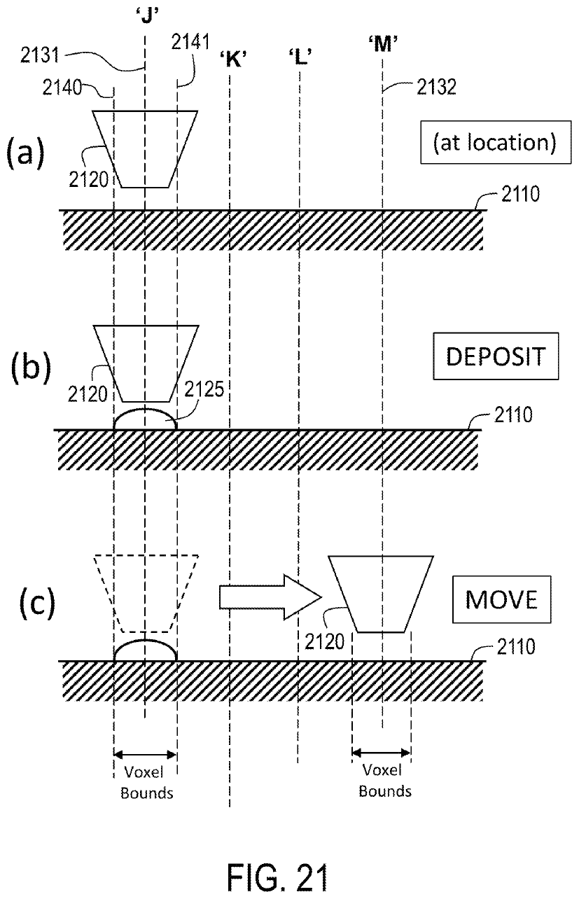

In accordance with preferred embodiments, the depositing element need only perform such a deposition once at each designated nominal X-Y location in the course of filling a given layer. In accordance with a preferred embodiment and as will be explained in conjunction with FIG. 21, a depositing element will generally remain positioned at a first XY location or within the bounds of the area being filled (that is, within one nominal radius of the voxel's nominal XY location) and then move to a second location that is distanced form the first by at least three voxel radii before performing a next deposit. This intentionally reduces the incidence of making deposits that are both adjacent physically and consecutive in the sequence of deposits.

The mass being deposited may be energized by, for example, pressure, heat, release of energy due to phase change or the release of chemical potential energy. Sources of heat to energize transferred matter may include, but are not limited to, electrical current flow and ohmic heating, conduction, radiation, convection from other heat-laden sources, electrical arc or plasma, combustion flame, sonic energy, friction, electrical inductive heating or electromagnetic radiation, such as photonic energy or radio waves. The mass being deposited may be energized by any one of the above or by simultaneous or sequential combinations thereof.

As illustrative examples, a first group of diagrams, FIGS. 14A-14D, and a second group of diagrams, FIGS. 14E-14H, depict two processes capable of depositing a material in a manner consistent with a single-mass transfer as just described. FIGS. 14A-14D are representative of a process known as cold metal transfer (CMT) which is considered one form of gas metal arc welding (GMAW) as was explained earlier. A surface upon which a quantity of material is to be deposited is shown as substrate 1410, which may be a build surface on which to initiate construction of an object in layers or which may represent layers of material that have been previously deposited. A tip of a depositor device 1420 or ‘depositor’ is shown (in highly simplified cross-section) as having a central passage 1423 through which a wire 1424, comprising the material to be deposited, is fed outward in a controlled fashion and protrudes from the tip of the depositor.

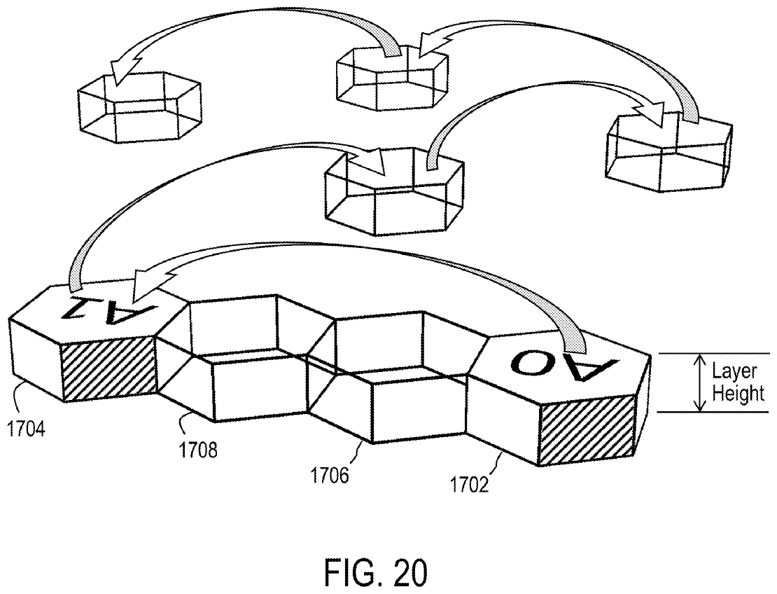

Depositing device 1420 may comprise electrodes and additional passages (not shown) for carrying a shielding gas. A flow of an inert shielding gas may be directed into the vicinity of the where wire 1424 will make contact with substrate 1410 and this flow may need to commence some time before the deposition (pre-purge) and continue for some time afterward (post-purge) to prevent unwanted oxidation. (If applicable, the times to conduct pre-purging upon arrival at a nominal deposit location and to dwell at the location for post-purging shall be assumed to be included in the overall cycle times depicted elsewhere herein, such as in FIGS. 20 and 24A-D.) Wire 1424 is electrically coupled to a source of welding electrical power that is also coupled to substrate 1410 and that creates sufficient voltage and current to create an electrical arc 1430 as the end of the wire comes into close proximity with substrate 1410. (See FIG. 14A.) Arc 1430 heats the end of wire 1424 as the wire is fed outward and approaches substrate 1410. At some point, wire 1424 makes solid electrical contact with substrate 1410, effectively creating a short circuit across the arc gap. (See FIG. 14B.)

The end of the wire is thrust towards the substrate and, having been heated by the arc, deforms and fuses with the substrate to form a cooling deposited mass 1425. As shown in FIG. 14C, wire 1424 is withdrawn and separates from deposited mass 1425 which has been transferred to, and become part of, the substrate. The short circuit now having been opened, electrical arc 1430 can be resumed, as depicted in FIG. 14D. In the context of the present teachings, the depositing device may move to a different location prior to restarting the electrical arc.

Thus, a single, consolidated mass is delivered in a single action by the depositor at a given location contributing to the formation of a layer, preferably a monolayer, comprising many such deposits.

The group of FIGS. 14E-14H portrays an alternative process that also comports with a single-mass transfer. In FIG. 14E, depositor 1420 is shown, in cutaway view, to comprise a cylindrical passage 1423 through which wire 1424 is fed towards substrate 1410. A fixed amount of wire 1424 is fed to issue from the end of depositor 1420. Next, as shown in FIG. 14F, a flame or momentary electrical discharge, delivered by moving electrode 1431, is used to melt the protruding portion of wire 1424 such that it forms ball 1426 due to surface tension. Depositor 1420 then moves toward the substrate, trapping ball 1426 and forcing it into contact with the substrate as shown in FIG. 14G. Ball 1426 attaches to the substrate by a combination of heat, pressure, sonic energy, friction due to scrubbing motion or other effects. The ball typically deforms or flattens as shown in FIG. 14G. The upper surface of the ball mass 1435 may be shaped or tooled by the tip of depositor 1420. After the attachment is made, depositor 1420 and wire 1424 are raised together. To accomplish this, wire 1424 may be momentarily mechanically clamped by a mechanism in depositor 1420 as shown in FIG. 14H. The tip of the wire 1424 may be caused to selectively separate from the secured ball mass at neck portion 1427 by, for example, applying slight shearing motion to the depositor before lifting or by applying sonic energy to cause localized work hardening at the junction between ball and wire. The depositor may then proceed to other locations and perform similar deposits until the layer has been suitably filled with material as necessary in the course of constructing a given object. Here again, a single, consolidated mass is delivered in a single action by the depositor at a given location contributing to the formation of a layer, preferably a monolayer, comprising many such deposits.

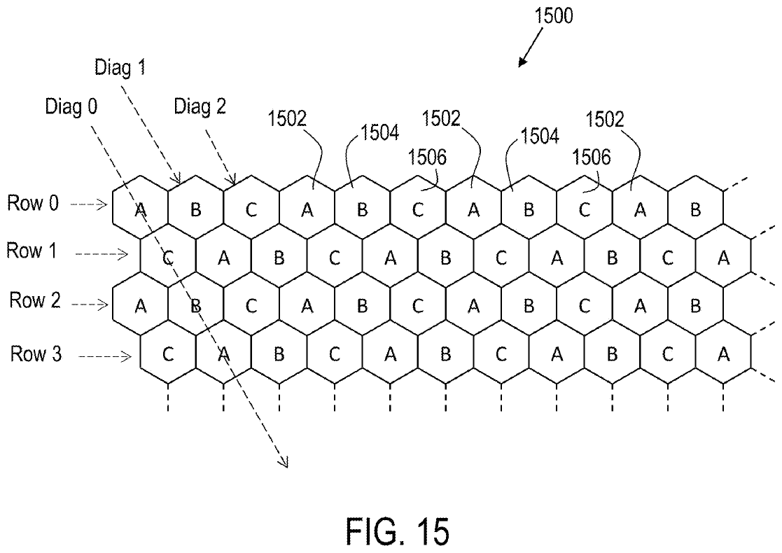

FIG. 15 depicts how an array of closely packed deposits may be planned to form a 2D layer or sheet. More particularly, FIG. 15 shows an array of voxel boundaries 1500 and each voxel boundary is depicted as being hexagonal, though other tessellated arrangements of regular or irregular polygons may suffice as well. It should be made clear that each ‘voxel’, per se, is a mathematical representation of a volume having location and boundaries specified in three-dimensional coordinates whereas array 1500 represents the two-dimensional areas that are formed when a plane intersects myriad adjoining voxels. For convenience in the explanation that follows, each location within array 1500 may be referred to as a ‘voxel boundary’, voxel space' or simply a ‘voxel’ because it corresponds to a specific voxel location in space and the bounds of the voxel within the plane of the tessellation pattern. In the context of a layer-wise pattern, each voxel space is said to have a nominal XY location, which may correspond to, for example, the center or centroid of the voxel-bounded space when viewed in a two-dimensional plane.

Within array 1500, an alternating regular arrangement of designations of the voxels is represented in that a first subset 1502 are designated with the letter ‘A’, a second subset of voxels 1504 are designated with the letter ‘B’, and a final subset 1506 of the remainder of the voxels are designated with the letter ‘C’.

The layer shown is part of a general field of voxel boundaries just showing a hypothetical solidly filled pattern. Generally, only a subset of such an array will be needed to form an object shape for a given layer. Object-specific layer contours, derived from ‘slicing’ a digital data model representing the three-dimensional shape of the object, are to be imposed as explained elsewhere herein conjunction with FIGS. 3, 10 and 19.

The hexagonal outlines approximate the mating interfaces as roughly spherical or cylindrical deposits are placed in close proximity. For practical purposes, describing and manipulating each deposit as a hexagonal shape simplifies calculations during modeling and simulations.

It is important to note that, even though the array of fillable voxels shows adjoining positions, the voxels need not be filled in a consecutively sequenced, side-by-side manner. In fact, in accordance with the present teachings, notable advantages are achieved by avoiding such a pattern of consecutive deposits that are physically adjacent. In many material deposition techniques, such as cold metal transfer, substantial heat energy may be imparted to a substrate as energized deposits are made. Even distribution of heat energy across a layer and over time is considered generally desirable to avoid hot spots and extreme temperature gradients, thereby reducing stresses within the object being constructed.

One way to generally assure that heat-carrying deposit events are distributed both spatially across a layer and temporally in terms of sequence is to designate groupings of voxels as shown in FIG. 15.

The voxels are labeled ‘A’, ‘B’ and ‘C’ in a pattern such that each unit is surrounded only by voxels having a different label. For example, no ‘A’ voxel is adjacent to another ‘A’ voxel. This pattern is referred to herein as ‘soccer sort’ because the intermeshing of groups of hexagons resembles the manner in which like-colored panels on a soccer ball are separated by a complementary color rather than adjoining one another.

Applied in the present context, in a one-dimensional time-ordered sequence of locations at which deposits will be made (as planned by the operation of sorter 78), the placement of two consecutive deposits in contact with one another, which would undesirably concentrate heat in one vicinity within a short period of time, is averted by simply arranging the sequence to cause all ‘A’-designed locations to be filled by material deposition, followed by ‘B’ and ‘C’ locations.

As deposits are made according to ‘A’-designated locations (subset 1502), each deposit is isolated from any side-to-side contact and heat mainly dissipates by conduction into the underlying substrate or underlying layers of the same build. (See FIG. 10C.) As deposits are made according to ‘B’-designated locations (subset 1504), each new deposit is isolated on at least three sides and on the other three sides it makes contact within ‘A’-designated deposits that have already cooled substantially. (See FIG. 10D.) Finally, as deposits are made according to ‘C’-designated locations (subset 1506), each will be placed in contact surrounded by previously deposited ‘A’ and ‘B’ locations that have already been cooling for some time. (See FIG. 10F.)

FIG. 16 presents an example time-ordered sequential list 1600 of deposit locations as might correspond to performing deposits in a sequence as depicted in FIG. 15. Time-ordered sequential list of deposit locations may exist as structured data in a computing system and is effectively a series of instructions by which a 3D printing system would move a depositor to specific locations and perform deposits of build material, eventually filling a layer as was shown in FIG. 15. In FIG. 16, each record 1640 is shown be indexed by a sequence number 1602 and is shown to comprise X- and Y-location coordinates field 1606. (In an actual data structure, sequence number 1602 may be inherent by array indexing or linking order within a linked list. It may be unnecessary to explicitly include a sequence number as a data field within each record, but sequence number 1602 is shown to facilitate the explanation that follows and to represent the relative order of appearance within an array, linked list or other sorted data structure.)

Record 1640 is merely illustrative and may, in some implementations, comprise a lesser or greater number of fields or may comprise alternative fields. The data fields shown for record 1640 may be distributed among other structures, such as separate tables within a relational database. Record 1640 is shown to comprise a ‘Tool’ field 1604 which may be useful when multiple depositors or other effectors are in use. A ‘Point Name’ field 1605 may contain a textual name or other convenient reference to uniquely specify a voxel space. A ‘Mass’ field 1608 and an ‘Energy’ field 1610 may express the amount of material to be deposited and the amount of energy to be imparted in making the deposit while at the nominal location specified in location field 1606. While these fields are shown as examples, it is contemplated that these fields may be replaced by such data as expressions of material feed instructions to a motor (perhaps driving wire 1424 forward) or by welding current and time duration (corresponding to a specified total energy delivery into the deposited mass). An estimated time-of-arrival or ‘ETA’ field 1612 may optionally be included to indicate the time within the build that the specified deposit is expected to occur. Although, this can be estimated or calculated without a dedicated field within a record 1640, this stored value may be beneficial for dynamic collision avoidance when fabrication system 10 is implemented with multiple independently moving depositors.

Aside from being ‘time-ordered’ in a sense implied by being a ‘sequence’, the ‘time-ordered’ aspect recited herein also acknowledges a possibility of including, in each instruction record, a time-related data field indicating when the deposit will occur. This field can be used as an ‘ETA’ of sorts to estimate cumulative build times or as an explicit command or an encoding for a specific time that a deposit should occur. In the case where multiple separately moving depositors may reach into a shared space, the inclusion of timing information allows for detecting collision possibilities, especially when an unplanned delay affecting one subsystem during a build may shift timings and create new potential collision instances. The embedded. timing information can help detect collision risks and then be edited, along with dynamic re-sequencing of the list, to avert interferences and allow the build to continue.)

A ‘Dwell’ field 1614 may be included to encode for a time delay between deposits or before or after each location-to-location move corresponding to various delay times that will be explained in the context of FIGS. 24A-24D. A ‘Weight’ field 1616 may be used for assigning a value to a voxel location as may be used by various heuristics to decide the sequencing of material deposit locations. Weight field 1616 may reflect whether one candidate ‘next location’ for a deposit is advantageous some another location.

Notably in FIG. 16, a first grouping of entries 1630 at the top of list 1600 shows that all of the ‘A’ designated locations are to be deposited first, followed by group 1632 comprising all of the ‘B’ designated locations and then finally, in group 1634, all of the ‘C’ designated locations. Absent other considerations, the ordering of ‘A-B-C’ is presumed arbitrary and the same objectives could be achieved even if the sequencing of groups were, say, ‘B-C-A’ or the if these grouping designations were shifted by a row or by a diagonal. (See FIG. 15.) Furthermore, although the general ordering of groups tends to automatically prevent consecutive deposits of material into adjoining spaces, it is not to be construed as an inviolate rule that, for example, that no ‘A’-designated locations may be interspersed with any ‘B’-designated locations in accordance with the present teachings. On the contrary, as will be explained elsewhere herein, there are circumstances where sequencing may be intentionally altered to accomplish control objectives and which may cause different initial groupings to be deposited in an interspersed ordering. Note that non-adjacency of consecutively ordered deposits can still be achieved in almost all cases because, for a given ‘A’-designated voxel space, there are generally many distant ‘B’ and ‘C’ voxel spaces that could be deposited next without directly contacting the ‘A’-designated space.

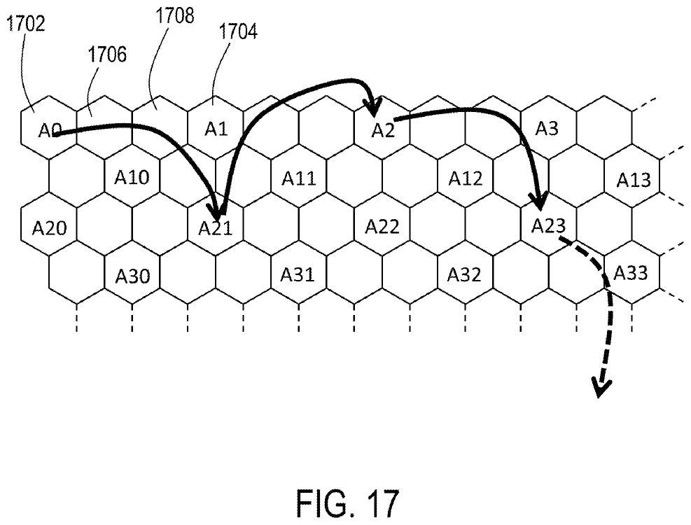

FIG. 17 is a variation of the pattern of voxel boundaries that was shown in FIG. 15 and illustrates that, to even further assure distribution of deposited locations over time, a sequence of performing deposits that are ‘A’-designated locations may be further scattered spatiotemporally within the ‘A’ subset. As shown by the arrows in this example, filling of voxels labeled ‘A0’, ‘A21’, ‘A2’ and ‘A23’ are performed in sequence, followed by deposits at other parts of the layer that are not shown in FIG. 17. This is as an alternative to executing all of the ‘A’-designated locations in close proximity, such as a sequence ‘A0’, ‘A1’, ‘A2’, ‘A3’ and so forth, or according to ‘nearest neighbor’ priority as in ‘A0’, ‘A20’, ‘A10’, ‘A1’. This may at first seem inconsequential because all of the voxel locations do eventually get filled (subject to the masking of voxels to form a particular shape) but the filling order affects, and allows for control over, thermal behavior as the additive process proceeds to build an object.

Even among the ‘A’-designated locations it is possible to further scatter and distribute the injection of energy into the part to improve the evenness of energy injection and resultant temperature rises. Furthermore, in consideration of the finite travel time that it takes for the machinery of fabrication system 10 to move a depositor from one location to a next location, there is a trade-off involving the distance of travel between successive deposits and the time that it takes to make such moves. Even though it may be possible to arrange a sequential list to cause consecutive deposits to be 20 or 50 voxel compartments away in the voxel pattern and the depositor could jump back and forth over considerable distances further increasing the distribution, the overall time to build a part would start to increase excessively. Accordingly, it is contemplated that, depending on part geometry, there may be optimal distances between successive deposits—even within each subset of ‘A’, ‘B’ or ‘C’-designated voxels—to achieve both evenness of heating and reasonable tool travel times. In view of cooling behaviors, there may be an optimal average travel time and distance to allow between instances of discrete material deposits for each given layer of a given part.

As a result of the sequencing approach taught by way of example herein, a general pattern is established wherein: a first-applied group of the deposits to form a given layer will be each made upon a substrate or previously deposited layer and, at the time of being deposited, will not be formed in contact with other deposited materials within the same group; a secondly-applied group of the deposits will be made in contact with the substrate or previously deposited layer and also in contact with at least one previous deposit from the first-applied group; and a thirdly-applied group of deposits will contact the substrate underneath, as well as at least one of the prior deposits from first-applied group and at least one of the prior deposits from the secondly-applied group. In a given layer, there may be exceptions depending on part shape and voxel pattern alignment, but the majority of deposits forming a layer (or a build comprising multiple layers) will fall into one of these categories. As layer of deposited material is formed in accordance with preferred embodiments, the proportion of deposits that can, by proper sequencing, be formed in adherence to the general principle of assuring non-adjacency of consecutive deposits may often be 100% or may fall in the any of ranges of 50% to 100%, 60% to 100%, 80% to 100%, 90% to 100%, 80% to 90%, 80% to 95%, or the like.

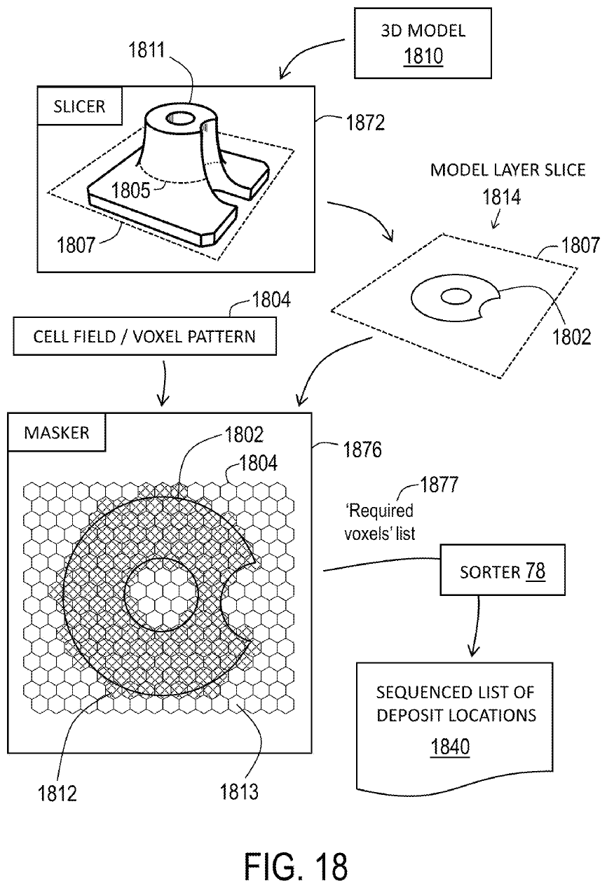

FIG. 18 depicts a progression of data descriptions involved in forming a part blank based upon a three-dimensional model representing the outer surfaces of a corresponding final part. In FIG. 18, the final shape of an example part to be fabricated is described by 3D model 1810. 3D model 1810 is provided as input to slicer application ('slicer') 1872, which may be an application operating on a personal computer or the like and providing a display approximately as shown (although some slicers operate without providing a display to an end user.) The image of slicer application 1872 shows a typical display of a three-dimensional shape 1811 rendered based on model 1810 and then shows a conceptual view of a plane 1807 parallel to the base of shape 1811 or parallel to the build platform that will be used during additive manufacturing, assuming that shape 1811 is to be formed in the orientation shown. Plane 1807 is depicted as intersecting shape 1811 part way up the total height of shape 1811 and the results of the intersection between the plane and the shape is indicated, for example, by a ‘contour’ or ‘curve’ 1805. Of course, to produce an entire blank part, the intersection of many such planes 1807 at different incremental heights will be performed by slicer 1872 to form a composite set of data for all part layers. A layer-by-layer visualization of how each plane 1807 intersects shape 1811 is usually option within a slicer application and it is very common for an end-user to invoke slicer 1872 without reviewing each layer slice. However, at least for illustrating the concept of the slicing of shape 1811, a particular “model layer slice” 1814 is shown representing one of many such model layer slices obtained by the operation of slicer 1872. Model layer slice 1814 shows that when an intersection is computed for a particular plane 1807 at a given vertical height along shape 1811, the result is contour 1802 in this example. The action of slicer 1872 corresponds to the role of slicer 72 as was depicted in FIGS. 12 and 13 earlier.

Next, model layer slice 1814 is combined with, or compared to, what may be termed a ‘cell field’ or a ‘voxel pattern’ 1804 which may resemble the pattern shown in FIG. 15 and will have been created by the action of cell generator 74 depicted in FIGS. 12 and 13. Within masker 1876, model layer slice 1814 is aligned with pattern 1804 to determine which cells or voxel locations within pattern 1804 should be included in order to implement or fill in the layer outline expressed in contour 1802. For the particular model layer slice 1814 shown having contour 1802, the specific group of voxels for inclusion by the operation of masker 1876 are shown as shaded voxels 1812. These are referred to as the ‘required voxels’ for the layer. Non-shaded voxels 1813 within pattern 1804 represent voxel locations for which no material needs to be deposited to form the part blank depicted by shape 1811. (For simplicity, this example does not involve support structures as might be required for other parts that have overhangs.)

A listing of the shaded voxels and their specific locations within pattern 1804 form a ‘raw’ list of voxels 1877 for inclusion but as yet the sequence in which the voxel spaces are to be filled with material has not been established. The arrangement of required voxels into a specific order is performed by sorter 78 as described earlier in conjunction with FIGS. 12 and 13. Sorter 78 acts to arrange the list of required voxels into a particular temporal sequence, such as by ‘A-B-C’ groupings as described in connection with FIG. 15 and possibly further by the actions of processes to optimize temperature control as will be described later. The result of the action of sorter 78 is a sequential list of deposit locations 1840 which may be formatted, for example, as in FIG. 16 and which will also correspond to output of process 2200 to be described later.

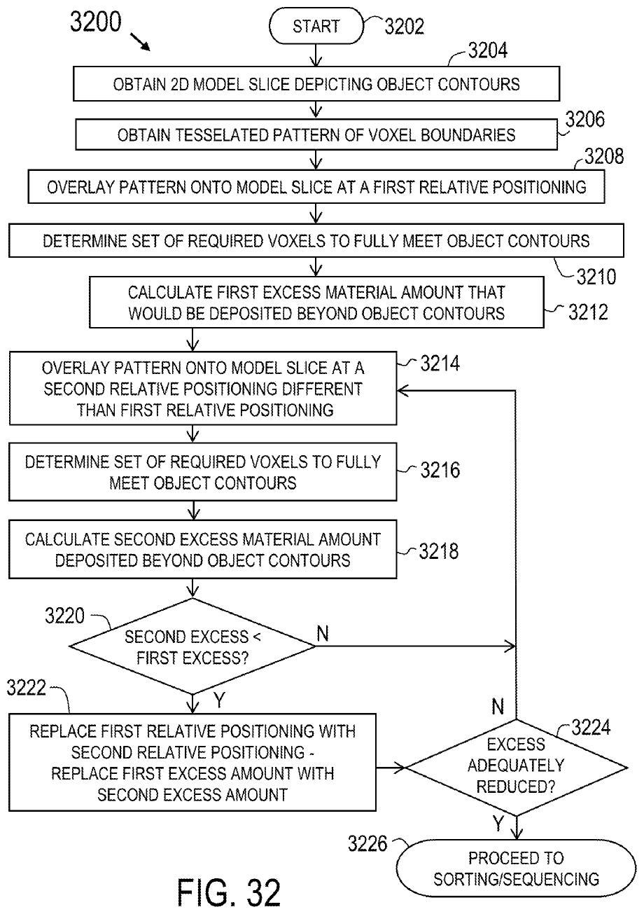

The operation of masker 1876 may include evaluating multiple different alignments between pattern 1804 and contour 1802 and selecting a specific alignment that efficiently fulfills a given contour 1802 by material deposition according to specific voxel spaces. Processes for performing such refinements by masker 1876 are later shown and described in conjunction with FIG. 32.

FIG. 19 depicts a manner in which a single layer of a model that describes the shape of an object to be built is compared to an array of voxels available for being filled in the course of building a layer of an object. FIG. 19 may be compared to FIGS. 3 and FIG. 10A shown earlier. Contour 1902 of the object's shape for the particular layer is shown as a dashed line superimposed upon a portion of a voxel pattern similar to that shown in FIG. 15. Voxel pattern 1904 will have been created by cell generator 74 shown in FIGS. 12 and 13 earlier. Masker 76 then decides, in the context of this relative positioning, which voxel spaces need to be filled with material to completely ensure that there is material at all points along the contour 1902 of the object to be built. (Otherwise, the finished object would exhibit surface voids when the additively manufactured blank is machined to final size.) As mentioned earlier, for creating a blank part that will undergo machining to final shape, this most often involves depositing materials into voxel spaces whose boundaries extend outside the boundaries of part contour(s) 1902.

The output of masker 76 will simply be an indication of which voxel spaces in the pattern need to be included in the layer so that material will be deposited at the corresponding locations. This information is then provided to sorter 78 (shown in FIGS. 12 and 13) that compiles (or receives from masker 76) a list of only the required voxel locations and determines the specific sequencing of the voxel locations and builds a one-dimensional time-ordered sequential list for filling the voxels that will constitute the particular layer. In FIG. 19, for example, a voxel within pattern 1904 that is not needed to contribute to filling the volume encompassed by the object contour 1902 is shown as voxel space 1910. The location for voxel space 1910 will not be included in a list of locations or waypoints at which the depositor will act the course of actually building the part. On the other hand, a shaded voxel space 1912 is designated as a required voxel space to be included. among the list of locations to be filled by the depositor in order to form the part represented by the shape of contour 1902. (To facilitate explanation, the non-shaded voxel spaces are labeled in a regular pattern whereas the shaded voxel spaces lack labels but do adhere to the same labeling pattern.)

The shaded set of required voxel locations for providing material along contour 1902 and providing solid infill are identified in a sequential list of voxel locations 1920, generated by compiling the list of the shaded voxel spaces (by the action of masker 76) then by sorting into a one-dimensional sequence by sorter 78. Note that, for list 1920, only the voxel label and XY location data fields are shown though, in actuality, each record in list 1920 will resemble record 1640 and comprise other fields.

FIG. 20 is a perspective view of voxels within a certain vicinity to illustrate an attribute of the so-called ‘soccer sort’ pattern. Referring briefly back to FIGS. 15 and 17, it may be observed that voxels that have the same letter designation assigned in the soccer sort are typically placed so that two intervening voxels which will generally be deposited at substantially different times according to the time-ordered sequential list. For example, referring to FIG. 17, voxel spaces 1702 and 1704 may be the sites of corresponding deposits well before the intermediary adjacent voxel spaces 1706, 1708 will be filled. In FIG. 20 then, it is shown that after depositing material within the location corresponding to voxel 1702, the depositor may move directly to another location that is several voxel diameters away, or even further, for the sake of distributing the input of energy across the part layer that is being built. Following the deposition of material into location indicated by voxel 1704, the depositor may move to many other locations and perform deposits, for example, at least in fulfillment of all of the ‘A’-designated voxels before returning to fill one of the intermediary voxels 1706, 1708 which may be ‘B’- or ‘C’-designated. This attribute of avoiding the deposition of consecutive depositions material into physically adjacent or adjoining voxels is highly preferable in accordance with the present teachings and tends to be inherently favored by performing the soccer sort shown.

Another useful consequence of creating a time-ordered sequential list by applying a soccer sort pattern 1500 as a default is explained in connection with FIG. 21. A nozzle or depositor tip 2120 is shown in proximity to a substrate 2110 which, as described previously, can be a build substrate upon which to create an initial layer of the part or may represent previous layers of material that have been deposited. In FIG. 21., depositor tip 2120 is seen to be aligned with nominal location (indicated by dashed centerline 2131) corresponding to, or which may be likened to, the location of voxel 1702 shown in FIG. 20. Depositor tip 2120 remains within the bounds of nominal location as indicated by dashed lines 2140 and 2141, until the instructed material deposit has been made at nominal location ‘J’. FIG. 21A depicts a preparatory step of positioning the nozzle at nominal location FIG. 21B corresponds to the action of depositor tip 2120 performing a material deposit, such as by a single-mass transfer, to form a mass 2125 that becomes attached to substrate 2110 while depositor tip remains substantially within boundaries 2140, 2141 of the nominal voxel location ‘J’. FIG. 21C corresponds to depositor tip 2120, having concluded its deposition at nominal location T, moving then to another nominal location ‘M’ (center line 2132) that is preferably distant from nominal location ‘J’ by at least three times a voxel radius and, in practice, considerably further than three times a voxel radius. This action avoids high concentration of energy input into a small area within a short period of time. Another characteristic evident in FIG. 21 (and explained in FIGS. 24A-D to follow) is the non-concurrency between the act of moving between nominal deposit locations and the act of depositing material at a location.

It is noted that with, polymer extrusion 3D printers for example, it is possible to encounter situations in which an extruder fills a small interior space then moves without extruding (‘travels’) to another location perhaps to fill another tiny interior space. Filling the small interior spaces may call for moving the extruder along a small tool path, resulting in brief but continuous extrusion over more than the width of the extruded head, but it is conceivable that an extruder could be directed by slicer-generated instructions to deposit a miniscule trace. In polymer extrusion or bead-forming weld process, these short-deposit occurrences are incidental or minimal and are generally avoided because of the inherent inefficiency of having an extruder waste time moving yet accomplishing very little volume filling. Slicers often disregard the filling of spaces that are below a threshold size and, in all such cases, the slight void to be filled is surrounded by extruded. traces rather than other adjoining pinpoint-filled areas. With these common bead-forming processes, the overwhelming majority of the part is designed to be efficiently formed by depositing of material as the depositing element moves along a path to form a continuously deposited bead. In contrast, the present teachings recognize and maximize certain advantages of intentionally non-continuous deposition that have been heretofore unappreciated, such as fine temperature management by resequencing of scheduled unit deposits, enablement of enlarged unit-deposit volumes and improved coordination opportunities when multiple robotic depositors collaboratively build a single part. Consistent with the present teachings, the formation of a continuous bead is de-emphasized in favor of achieving a roughly formed blank part to undergo subsequent machining while realizing other compelling advantages explained herein.

Typically in accordance with preferred embodiments, when a part is built in sequential layers or strata, a first deposit that has been made in the course of depositing a first layer will not receive any other mass deposited on top until all of the other deposits for the first layer have been completed. In other words, a typical sequencing of deposits encompassing two layers may involve, within a first layer, a first deposit, followed by at least one second deposit and preferably several more intervening deposits that are also within the first layer but not deposited in contact with the first deposit. Preferably after these other non-contacting deposits are made, at least one third deposit is made as part of the first layer that does contact the first deposit, and then any other deposits (some of which may contact the first deposit and others may not contact the first deposit) are made to complete the formation of the first layer. After the first layer is completed, a second layer may be built by continued deposits onto the first layer and one or more of these second layer deposits may make contact with the ‘top’ surface of the first deposit.

It is acknowledged that in some systems, such as those employing multiple independently moving depositors, it may be possible to commence a second layer in some areas of a build even while a first layer is still being completed. The general pattern will be that a first deposit becomes surrounded by other deposits of the same layer before another deposit, such as from a subsequent build layer, is placed on top. This is in keeping with the general principle that each deposit completely fills an assigned voxel space defined by the layer thickness and that a unitary mass transfer sufficiently fills the voxel space such that only one mass transfer is needed at each distinct nominal location within a given build layer.

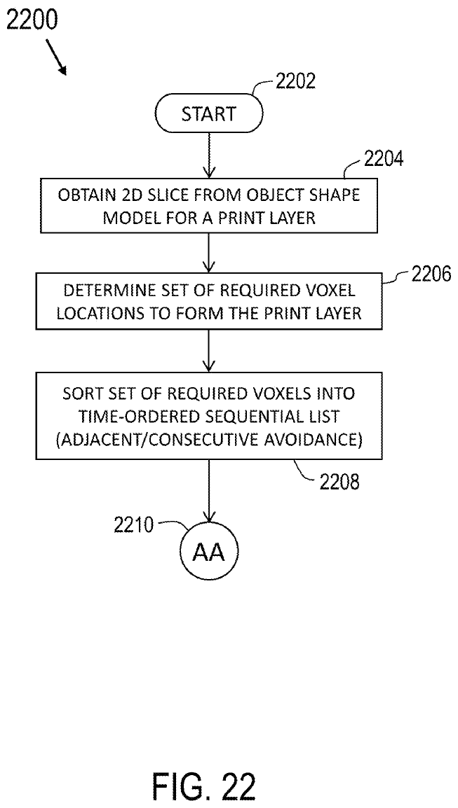

FIG. 22 depicts a process 2200 for preparing a time-ordered sequential list of deposit locations based upon a digital data model describing a final shape of an object that is to be built. More specifically, process 2200 yields a list of instructions for forming a blank by an additive process whereas other, later processes will remove material to render the finished contours. As this same process 2200 is applied at the outset for several other procedures that will be described below, process 2200 concludes with connector ‘AA’ which will lead to other subsequent processes to be explained separately.

Process 2200 commences with step 2202 upon the need to take at least one slice from a three-dimensional object model and to create a sequential list of instructions by which a depositor will be moved to specific locations in sequence and make discrete prescribed deposits at each location. Execution proceeds immediately to step 2204 referring to the process of obtaining a two-dimensional model slice which shows the contours of the object the height of that layer. This action was conceptually described in connection with FIG. 18 earlier.

Step 2206 refers to the act of applying masker 76 to identify specific voxels from within a voxel pattern (such as generalized pattern 1500), while observing to need to ensure that there is material present everywhere along the contour of the object. After a finite set of required voxels has been identified, each having a unique two-dimensional location within the given layer, step 2208 is undertaken to sort the set of required voxels into a one-dimensional time-ordered sequential list. Sorter 78, shown FIG. 12, creates the time-ordered sequential list which both directs the filling of the correct voxels for the given layer of the object and establishes an ordering that avoids making consecutive deposits into adjoining voxel spaces.

Once this time-ordered sequential list has been prepared in process 2200, then any of several subsequent processes take place. One such process that receives the output of process 2200 as an input or starting point is depicted in FIG. 23.

FIG. 23 takes place after step 2208 in FIG. 22 with the execution of step 2310. Whereas process 2200 generally relates to preparing a list of sequential instructions, process 2300 corresponds to interpreting the file and carrying out the steps to actually build an object. it should be noted that the result of process 2200 which may be a data structure or data file could be stored on a fixed medium or transmitted or prepared at a time and place considerably distant from the execution of process 2300. Alternatively, and as will be explained further below, process 2200 may occur immediately before, or in continuity with, the execution of process 2300 and in some instances may even be reiterated during the course of actually building the part as will be demonstrated with other techniques described herein. In the context of processing a time-ordered sequential list as created in step 2208, step 2310 is performed to retrieve one of the specific deposit location instructions from the list. One such deposit location instruction would correspond to, for example, a single record 1640 as was shown in FIG. 16.

Once an instruction has been retrieved, then step 2312 is executed to move the depositing device to the location coordinates listed on that line, in an action analogous to FIG. 21C. Then, in step 2314 and in analogy to FIG. 21B, a material deposit occurs, such as by a single-mass transfer event. Once the deposit is performed or attempted, then decision block 2316 is executed which refers to evaluating whether the deposit was successful. For some types of processes, it is possible that an attempted transfer of mass fails due to such factors as misfeed of raw materials (wire 1424) or failure to form a ball or an electrical arc as depicted in FIGS. 14A-B. Accordingly, decision step 2316 corresponds to determining whether or not any form of detectable error has occurred during the attempted deposit. If it is determined that the deposit was not successfully made, then step 2318 is performed to take corrective action, such as by ensuring that a wire is fed from a nozzle of the depositor, by switching depositor nozzles in case one is worn out or by alerting a human operator of the fabrication system to take corrective action. After such corrective action has occurred, then an attempt is made to complete the deposit at the specified location by returning the flow of execution to step 2314.

If and when, in step 2316, a deposit at the nominal location is detected to have been successful, then the flow of execution proceeds to another decision block 2320 to determine whether all deposit locations in the sequential list have been processed and, if so, process 2300 concludes in step 2321. Reaching this point signifies that all discrete deposits ordered for the subject layer have been completed, at which point the system may move to the next highest layer in the build, if any, and repeat all the steps above until all layers needed. for the part blank have been completed. If on the other hand, in step 2320, it is determined not all locations in sequential list have been processed, execution, optionally and in accordance with preferred embodiments, proceeds to step 2322 to assess the conditions of the system at large, or of the workpiece, as a result of the most recent deposit accomplished in step 2314. This may include assessing temperatures of the part, build stresses or other factors. While it is possible to simulate or predict many conditions that will be encountered before a build takes place, it is possible for some unforeseen circumstances to affect temperatures across an object being built. These sources of variation may include differences in convective airflow or forced airflow, the electrical resistance path through underlying layers of the build when welding currents are applied, concentrations of mass on previous layers underneath the current layer that is being built and variations in energy input to the mass that is being transferred, to name a few.

In step 2324 and based upon observations gathered in step 2322, a decision is made as to whether there is a need to delay the next deposit, such as to alleviate problems with undesirably high temperature buildup in some areas. Delaying new deposit events for a time may allow the energy that has been thus far transferred into the workpiece to dissipate for a time, allowing the part to cool off before additional deposits of material. If no delay is deemed necessary or beneficial for the build process in step 2324, then execution simply returns to step 2310 to retrieve the next deposit location from the time-ordered sequential list and to move to a different deposit location which would correspond to the action of moving to a next location some distance away as shown in FIG. 21C and in FIG. 20. Alternatively, if the operation of step 2320 determines that temperature conditions or other observable factors of the workpiece warrant delaying the next deposit event, then delay occurs by execution of step 2326 to, for example, delay movement of depositor tip 2120 as shown in FIG. 21C so that it momentarily dwells at nominal location ‘J’ for an additional period of time. Alternatively, the delay implemented in step 2326 could correspond to moving depositor tip 2120 to nominal location ‘M’ but then, once in place there, delaying the execution of a deposit as in FIG. BIB.

Note that steps 2322, 2324 implement contingency logic wherein the circumstances and success of the placement of a deposit, such as at nominal location ‘J’ shown in FIG. 21, is evaluated before the initiation of a deposit at another location, such as nominal location ‘M’ shown in FIG. 21.

FIGS. 24A through 24D show timing diagrams to explain the temporal relationships between the depositing action taken by depositor 2120 and the movement of the depositor to a different location carried out by motion mechanisms of fabrication system 10. FIGS. 24A-24D may be usefully viewed alongside FIGS. 21 and 23 during the following explanation. In FIG. 24A, time axis legend 2402 indicates that time progress is plotted left-to-right. A ‘depositing action’ trace 2410 reflects whether, at a given moment in time, the depositor is actively performing a deposit, such as by a single-mass transfer event, or is in an ‘idle’ state. Each vertical pulse 2405 along trace 2410 signifies an instance of depositing material, such as a single-mass transfer event.

Plotted along the same time axis as trace 2410, ‘depositor motion’ trace 2420 indicates, at a given time, whether the depositor is being moved by the system to a specified deposit location or is remaining at one of the nominal locations. Over a first time span 2440, the depositor is depicted as being in motion to approach the location for a specified deposit. Meanwhile, the depositor is not depositing any material. At a first point in time 2450, the depositor conies to rest at a first nominal location at which to perform a deposit. While the depositor remains substantially at the nominal location during time intervals 2441, 2442 the depositor remains effectively stationary or within the hounds of nominal location ‘N’. During this time, as shown by depositing action trace 2410, the depositor performs a deposit as indicated by a pulse 2405 in time interval 2441. After this depositing action and during interval 2442, the success of the deposit and, optionally, the conditions of the process may be assessed as described in steps 2316 and 2322 of process 2300. At time 2451, upon sensing a successful deposit and no conditions warranting a delay, the location of a next deposit ‘N+1’ is obtained from the sequential list (returning to step 2310).

Then, during time interval 2444, trace 2420 reflects that the depositor goes into motion to move the depositor to location N+1 and comes to a stop there, whereupon another depositing action occurs during time interval 2446 and another assessment is done to assess the success of deposit ‘N+1’ during time interval 2448 before moving on to yet other deposits.

Turning now to FIG. 24B, a slightly different situation is presented which may correspond to the action of steps 2324, 2326 in process 2300. Whereas most of the timing features are analogous to what was shown in FIG. 24A, FIG. 24B specifically includes an additional waiting period 2480 between time intervals 2444 and 2446. As described earlier, this added delay (implemented by step 2326) effectively increases the time delay 2482 between deposits which, in practical terms, may allow the part under construction to cool somewhat before continuing to add more heat-imparting deposits.

FIG. 24C shows an alternative timing which may offer efficiency in some circumstances. FIG. 24C depicts that the assessment of successful material deposit at location ‘N’ may occur while the system is moving the depositor to a next deposit location ‘N+1’. For a system that is mostly reliable in making successful deposits and for which a need to introduce delay due to thermal considerations is unlikely, the simultaneous assessment and movement of the depositor to a next location may offer considerable time efficiency, as noted by shortened interval 2484 between depositing masses of material onto the workpiece. Time interval 2488 represents consecutive execution or combination of intervals 2442, 2444 that were executed sequentially in FIG. 24A. Note that, in comparing FIG. 24C to previous timing diagrams, the time interval 2484 between deposits is shorter than time intervals 2404 and 2482. Although some deposit mechanisms can exhibit instantly detectable successes/failures (such as a ‘misfire’ or misfeed in a CMT process), there can be an additional need for visual or thermal configurations, some of which take time or require the depositor to move out of view before the observation can be made. The trade-off with overlapping moving and assessing is that, if a problem with the deposit at ‘N’ is detected that requires returning to that location, then additional travel time is incurred. Again, if this is a rare event, then the occasional impact on the overall build time is more than compensated by the shortening of interval 2484 over the majority of the build.

Finally, in FIG. 24D, a timing diagram is depicted for the situation that, as in step 2316 of process 2300, a fault is detected indicating that the material transfer did not occur successfully and is to be reattempted. In this diagram, a first attempt at the deposit occurs over time interval 2441 and the assessment of the success of the deposit occurs over time interval 2442. However, unlike in FIG. 24A, the determination corresponding to step 2316 is that the mass deposit was unsuccessful and there is a need to reattempt. Under these conditions, step 2318 would be undertaken to take corrective action, as appropriate, to prepare for reattempting the material deposition. Executed next, step 2314 corresponds to reattempting depositing action (presented by pulse 2490) followed by reassessment over time interval 2492. If the reattempt is detected as successful, then the logic of process 2300 simply results in continuing to make other deposits as planned according to the time-ordered sequential list by the execution of steps 2310 and so forth.

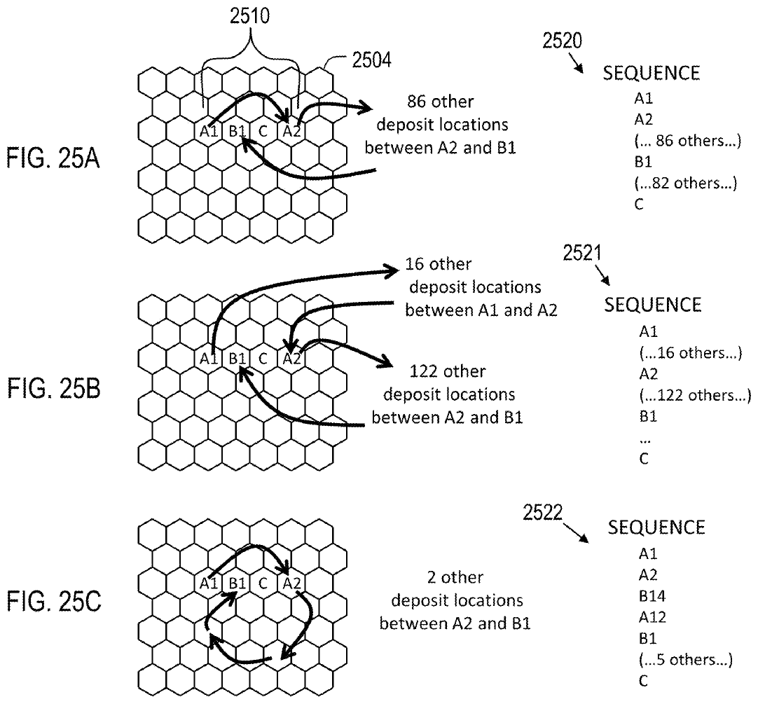

Referring now to FIGS. 25A-C of the drawings, three different scenarios are shown to explain how a time-ordered sequential list may be manipulated to control the delay between material deposits in a specific locality and, by doing so, effectively control temperature or other characteristics during a build process. In FIGS. 25A-C, an example group 2510 is shown to comprise four voxel locations, labeled ‘A1’, ‘A2’, ‘B1’ and ‘C’, as defined in the context of pattern 2504. These voxel locations are eventually filled with material but over different time spans. Specifically, in a first scenario shown in FIG. 25A and with reference to sequential list 2520, locations ‘A1’ and ‘A2’ are depicted as being deposited consecutively in sequence before the depositor moves on to, for example, 86 other locations before returning to provide material into voxel location ‘B1’. This may represent a typical or default ordering similar to that depicted in FIG. 16.

In FIG. 25B, the same voxel locations are eventually filled as in FIG. 25A, but sequencing between these and other voxel's fills achieve a distribution of energy injections over a longer period of time, as might serve to keep the vicinity of group 2510 from reaching an undesirably high temperature. As an advantage offered according to the present teachings, changing to sequence 2521, as a reorganized version of sequence 2520, the temperature profile within the vicinity of these four voxels can be adjusted. In this case, the conveyance of matter (and heat) to fill voxel location ‘A1’ is followed by deposits at 16 other locations outside the vicinity before filling of the ‘A2’ voxel location. This may be followed by deposits at 122 other locations before returning to the ‘B1’ location. This insertion of additional waypoints may be accomplished. by, for example, rearranging among the ‘B’-designated locations so that ‘B1’ is not necessarily the first ‘B’ voxel location at which a deposit will occur. The net effect is that the peak temperature in the vicinity of group 2510 will likely be lower using modified sequence 2521 than when executing original sequence 2520.

To demonstrate the opposite effect, FIG. 25C depicts an extremely short turnaround time for filling the same group of voxel locations, wherein locations ‘A1’ and ‘A2’ are deposited consecutively (but are still spatially non-adjacent) and then only two other voxels are deposited before returning to deposit into voxel space ‘B1’. This alternative sequence 2522, again a rearrangement of sequence 2520, results in a high delivery of heat energy into the vicinity over a short period of time, which may be desirable under some circumstances.

Considering all of the pairings of consecutive deposit instructions in an ordered list, it is preferred that any candidate rearrangements exhibit an acceptable proportion or percentage of ‘non-contacting’ pairings wherein the respective voxel spaces do not intersect or share any common faces, implying also that any materials filling these voxel spaces by consecutive discrete deposit actions do not make physical contact. Even with possible constraints imposed by part shape and thermal management, the percentage of non-contacting pairings of consecutive deposits should be maximized during rearrangement. In accordance with preferred embodiments, the percentage of non-contacting pairings achievable by rearrangement should reach ranges such as 50% to 100%, 60% to 100%, 70% to 100%, 80% to 100%, 80% to 90%, 80% to 95%, 90% to 100%, 95% to 100%, 97% to 100%, 99% to 100% and 99.9% to 100.0%. As an alternative assessment related to the distancing of consecutive deposits, each ‘non-contacting pairing’ may be defined by identifying vicinities around each of the respective voxel spaces bounded by a boundary distance ‘D’ from the nominal location of each voxel space and then determining that non-contacting pairing when the distance between the nominal locations is greater than three times the boundary distance ‘D’. Under this definition, the percentage of non-contacting pairs achievable by sequence rearrangement are comparable to the ranges listed above. Any computer or data processing context set forth herein may host a process for performing a rearrangement of deposit instructions as just described and the process may be encoded as software and embodied as one or more computer programming code segments present in non-transitory computer-readable media. Computer programming code segments residing on the non-transitory computer-readable media may also provide logic for invoking the rearrangement under conditions explained herein.

If the output of a masker 76 and sorter 78 has created an initial sequencing in which, for example in FIG. 25A, there is a moderate frequency with which the vicinity of group 2510 is touched by energy-delivering material deposits, it may be possible to re-sort the time-ordered sequential list more in accordance with sequence 2521 to alleviate excessive local temperatures or in accordance with sequence 2522 to enhance heat concentration, such as in areas where excessive cooling may create stresses in the part. The flexible resequencing of the list of deposit locations as just described provides unprecedented control over both the finite number of distant locations that are interposed between vicinal deposits and the deliberate time delay between discrete deposits, enabling fine control of temperature distribution over a layer as it is deposited. As will be explained later in connection with FIG. 28, it may be possible to reevaluate and rearrange the sequential list before an actual build occurs, by using modeling and simulation of heat flow to anticipate potential temperature related issues. Moreover, an initial sequential list of deposition locations may also be evaluated and re-sequenced dynamically during a build process based on real-time observations, such as thermal imaging. (This is described in conjunction with FIG. 29.)

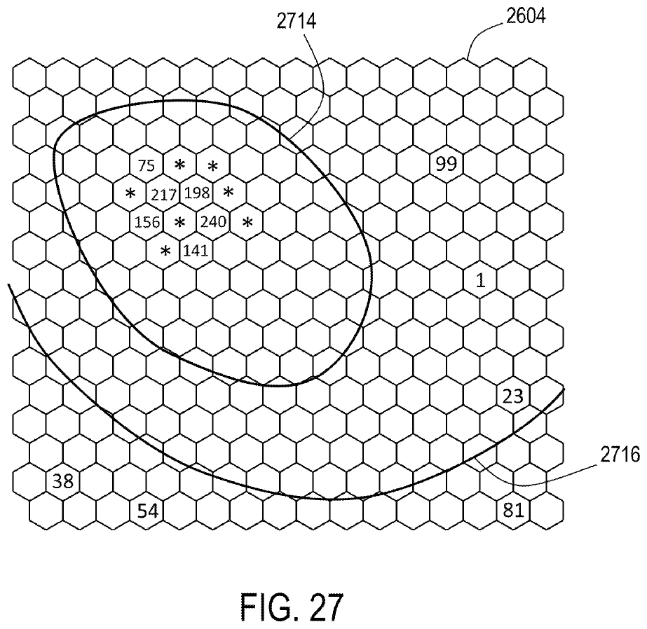

This attribute of flexibility is further explained with reference to FIGS. 26 and 27. FIG. 26 shows an array of voxel locations 2604 and, for the purposes of this example, it is assumed that all of the voxels shown are to be filled in the course of building a layer of part. Superimposed on this sketch are isotherms bracketing temperature ranges as may be either predicted through a simulation model or as may be determined by actual observations (infrared imaging) during the course of a build. For example, a first isotherm 2616 may represent a lower temperature transition that is within a desirable range for the workplace. Isotherms 2614, 2612, 2610 may depict the presence of escalating temperatures around a ‘hotspot’ inside isotherm 2610. The close spacing of isotherms along some directions also indicate steep temperature gradients, such as in the vicinity of the voxel labeled ‘38’. A number of specific voxels 2620 (those labeled with a sequence number or with an asterisk) are identified as falling within the hotspot region encompassed by isotherm 2610 and it is presumed desirable to take action to mitigate this anomalous region of high temperature buildup. As mentioned before, part of the high temperature buildup could be caused by previous layers of the build or to external cooling and heating influences. Some influences are not necessarily attributable to the original sequencing or are not necessarily foreseeable before the actual build takes place. Nevertheless, the sequence being used to build the layer by filling voxel locations indicated by array 2604 can be purposefully altered to respond to or compensate for the excessive heat buildup observed within isotherm 2610. The numbers within certain voxels in FIG. 26 depict the sequence within the time-ordered sequential list as may have been originally provided from sorter 78.

FIG. 27 depicts the same layer being built, and the same voxel locations being addressed, as in FIG. 26 but with the sequencing modified to improve the thermal issue that was evident in FIG. 26. It is noted that, for six of the specific voxels within the problematic range encompassed by isotherm 2610, the filling of these voxels is delayed and distributed geographically. The heat buildup within this vicinity is alleviated by effectively distributing these deposits both temporally and spatially. (The remaining voxels denoted with asterisks could be re-sequenced as well but are disregarded to keep the current explanation simple.) In FIG. 27, redrawn isotherms 2716 and 2714, representing like temperatures as isotherms 2616 and 2614 respectively, reflect a reduction in steep temperature gradients that were evident in FIG. 26. This curative measure is a direct result of re-sequencing the order in which discrete deposits occurred in this area. It is worth noting that ultimately all of the same voxel locations would be filled in FIGS. 26 and 27 but the thermal characteristics will have been managed by re-organizing the sequence of deposits.

FIG. 28 depicts a process 2800 by which a time ordered sequential list may be assessed in view of simulated build process and estimation of temperature profiles or other modeled characteristics that are revealed during the simulation. Process 2800 accepts as an initial input a tentative or initial time ordered sequential list as may have been prepared by process 2200 introduced earlier. In addition to the initial time ordered sequential list of deposit occasions, process 2800 receives, in step 2802, a planned or intended profile temperature, range of temperatures, cooling rates, stress characteristics or other desirable characteristics of the build that are to be monitored and compensated as necessary through resequencing.

Once one or more ranges of acceptable criteria to be maintained during the build (such as temperature limits) have been established or obtained in step 2802, then execution of process 2800 proceeds to step 2804 to set a nominal default delay between deposit events. This initial global value is likely to be empirically derived for a given process, material or fabrication system but, as will be explained, this value may later be adjusted as needed to provide a better overall compliance with the characteristics that were established in step 2802. Once an initial time-ordered sequential list of deposit locations, a set of acceptable parameters and the nominal delay between depositions have been established in previous steps, then step 2806 is performed, which essentially involves carrying out a simulated build while monitoring to ensure that the behavior anticipated by the model remains in compliance with the desired parameters or profiles for the build.

The simulation of step 2806 can be by finite element analysis (FEA) in consideration of thermal conductivity and heat input and modeling the dissipation of heat from new heat-bearing deposits into the remainder of the structure or into the surroundings by radiation, conduction or convection.

Step 2806 refers to the simulated addition of a single deposited mass or of a small number of deposited masses in sequence followed by an assessment of the effects of those deposits. Each invocation of the step 2806 then refers to incrementing through a simulated build, applying one or a limited number of deposits at a time, rather than completing the simulation of an entire build. Working in conjunction with step 2806, decision step 2808 is performed in the course of monitoring for compliance and determining if unacceptable deviation from the planned behavior set forth in step 2802 is occurring as the simulation or the simulated build is occurring in step 2806.

If, in step 2808, it is determined that the simulated build has yet to exhibit unacceptable deviations from the criteria from step 2802, then the simulation is simply allowed to continue incrementally by returning to step 2806.

Alternatively, if in step 2808 there is detection of an unacceptable deviation from the planned behavior, then execution proceeds to step 2810 to further ascertain whether the deviation is localized within a part of the layer being built at the time or is distributed more or less evenly over the entire layer. If it is determined in step 2810 that the deviation from the planned behavior is of a distributed or generalized nature, then execution moves to step 2812 to change the delay settings globally for the build from the value that was set in step 2804 at the outset. This may be done to generally slow the entire build and reduce the rate at which heat is being introduced. Alternatively, the delay adjustment may apply to a single layer or a few recent layers rather than the entire build. Once the general delay settings have been changed step 2812 then the simulated build may be restarted (or reset to an earlier stage) by return to step 2806 with the new delay settings in place.

Returning to decision step 2810, if it is determined that the anomalous behavior is localized to a portion of the layer that is being built, then execution proceeds to step 2814 to identify specific voxel locations within the region of the detected deviation and to then perform resequencing of the time ordered sequential list. As with FIGS. 25-27, this action involves time-shifting deposits for some of the identified voxel locations to improve the overall thermal profile or other characteristics as needed to alleviate the deviation detected in step 2808.

Once this resequencing has taken place in step 2814 then it will be generally appropriate to reinitialize the simulated build in step 2806 according to an entirely new sequencing.

An optional step 2816 is shown for exercising another possible mechanism to improve thermal or other behaviors, essentially by subdividing one or more of the voxels in the problematic subset. This aspect is described later. Upon performing the resequencing step 2814 (and optionally step 2816) execution proceeds to step 2818 to determine whether all locations within the time-ordered sequential list have been processed. If so, then process 2800 concludes in step 2820 at which point a satisfactory plan for a sequenced deposit events to form a particular layer has been completed and has been refined to assure ongoing compliance with the process boundaries established in step 2802.

If, in step 2818, it is found that there are more deposit locations in the sequential list that have not yet been modeled, then execution returns to step 2806 to continue to perform the simulated build until all of the scheduled or listed deposits have been simulated. The net result of process 2800 is selectively making refinements to the sequential list that was initially produced by sorter 78, such refinements being made based on simulating the build and predicting where there may be unwanted temperature deviations or other characteristics.

FIGS. 26 and 27 portrayed a solution or algorithm to improve evenness of temperature across a layer, in essence, by increasing or decreasing frequency of heat injection at different vicinities. This evenness is not the only sort of desired outcome that might be expressed by criteria received in step 2802. A temperature profile provided in step 2802 may, in fact, call for higher temperatures to be developed at specific areas and. specific times during a build process. In some designs it may be desirable to intentionally concentrate heat, especially for enhancing cohesion, influencing microstructure or controlling cooling rates by keeping temperatures elevated in selective locations. For example, if a shape being built involves transitioning from a large flat area to a much smaller column, the desired temperature profile may call for elevated temperatures within the flat layer in the vicinity of where the column will start to be formed in a subsequent layer. Furthermore, the desired temperature profile may involve creating the higher temperatures later in the timeline of building the flat layer so that the localized peak temperatures developed will promote better fusion and heat-sharing with the adjoining column-forming layer. By virtue of the present teachings, a particular profile can be readily accommodated by controlling the sequential list to intentionally create concentrations of heat injection at certain times during the build and at certain locations. This may be likened to starting with a situation depicted in FIG. 27 and intentionally creating the concentrated temperature situation of FIG. 26.

The criteria set forth in step 2802 may or may not comprise expressions of strict threshold values for temperatures, temperature gradients, time rates of change, stress levels or other characteristics but may also optionally include expressions of average or RMS values based on multiple samples over an area or over time. Other possible expressions of criteria may be standard deviations for a value which exhibits a Gaussian distribution, a nominal range in support of statistical quality control or any of a number of other expressions of mathematical functions, such as proportions, integrals or derivatives, that delineate desirable and undesirable responses or behaviors for a given modeled part. Comprehensive adherence ‘scores’ may also be employed for both expressing and assessing desired build performance, derived from any one or a combination of the above. These various expressions are contemplated by way of example but are not to be construed as limiting.

In the course of performing the simulation in step 2806 and possibly detecting a notable deviation in step 2808, it may not be necessary to completely reinitiate the entire simulated build but rather to address the deviation henceforth within the sequence or to effectively reverse the simulation by a few increments of material deposition and begin to re-factor or re-sequence the remaining part of the sequential list according to step 2814 and to continue the simulation from that point on. For example, if a simulated build demonstrates satisfactory compliance through three-quarters of its progress, then it may not be necessary to restart the entire simulated build but rather address the last half or last quarter of the build by performing a resequencing according to step 2814.

FIG. 29 presents a process 2900 which, like process 2800, starts with an initial time-ordered sequential list as a ‘first cut’ having been created by process 2200. In contrast to process 2800 which seeks to model and predict the compliance of a built process before the actual execution of the process to build a part, process 2900 relates to dynamically evaluating the status of a part as it is being built and invoking a resequencing of the sequential list to resolve issues as the build continues.

Process 2900 commences upon the submission of an initial sequential list, as might have been prepared by process 2200. (See connector 2210 labeled ‘AA’ originating in FIG. 22.) Execution immediately proceeds to step 2902 to retrieve a specific deposit location instruction from the sequential list. Once a deposit location instruction is retrieved, then step 2904 is executed to move the depositing device of fabrication system 10 to the specified nominal location at which the prescribed deposit is to be made according to the instruction. Step 2906, executed next, relates to performing a deposit, such as by a single-mass transfer event, at the nominal location and the success of making the mass deposit is assessed in decision step 2908. It is noted that some deposit mechanisms provide an immediate indication of success, such as by detecting electrical continuity, in which steps 2908 and 2906 would be, in a sense, executed concurrently. If it is determined that the mass deposit was not successful, then execution proceeds to step 2910 to take corrective action as necessary and to return to step 2906 and reattempt the deposit at the same location. This fault handling has been described earlier in conjunction with step 2318 and in FIGS. 24B and 24D. If, on the other hand in step 2908, it is determined that the mass deposit has been successful at the specified location, then decision step 2912 is performed to determine if all of the locations that were specified in the sequential list have been processed. if so, then execution of process 2900 concludes with block 2913 signifying that the specific layer of the build has been completed.

If, in step 2912, is determined that not all of the locations have been processed then, in step 2914, an assessment is made of the operational status of the system, as well as the state of the workpiece such as by thermal imaging, probing, temperature sensing, etc.

In step 2916 it is determined whether there is a need or foreseeable benefit to re-sequencing to address any issues or increasing concerns arising from the assessment of step 2914. If, in step 2916, a sufficient advantage is possible by performing a resequencing or shift in timing, then step 2918 is performed to resequence (by performing actions such as those described in FIGS. 25, 26 and 27) the remaining deposit location instructions within the sequential list that have not yet been performed during the build and then to take up execution in step 2902 based upon the newly resequenced list comprising instructions for the remainder of the voxel locations yet to be filled.

One contemplated mechanism for resequencing is culling out specific voxels that are in problematic areas and simply moving them to the end of the sequential list and performing them after the remainder of the voxels have been filled. Among these transplanted instructions, re-sorting or delay could be imposed if they happen to be too close physically. Another possibility contemplated is to place specific deposit locations later in the sequence but to favor re-inserting each deposit location at a position in the existing sequence when the depositor happens to approach the vicinity of the displaced deposit location while addressing other originally scheduled voxel-filling instructions.

Many algorithmic approaches are contemplated for performing rearrangement of instructions in the sequential list and arriving at a suitable final sequencing, whether fully composed before a build, retouched during a simulation or modified in the midst of an ongoing build. An intuitive, goal-driven rearrangement, as was conceptually depicted in FIGS. 26 and 27, may certainly accomplish the desired end result under many circumstances. Alternatively, a mathematical analysis may be performed that assigns a weighting factor to each voxel that is influenced by proximity to recent deposits and by having an optimal proximity to a current location of a depositor device. In particular, considering the need to avoid adjoining deposits in consecutive order while also matching location-to-location travel time to a nominal planned delay between deposits, next-location candidates may be more favorably weighted if they fall within a particular distance of a current location. For some layers of some parts, the contours may favor a point-to-point traversal path that resembles what may be colloquially termed a ‘spirographic’ pattern. Other contours may be best handled by a ‘chess knight’ traversal pattern familiar in mathematics.

Yet other techniques for evaluating possible sequences and more effectively reaching a ‘global optimum’ over a layer or entire build may rely on a more stochastic or probabilistic approach. A general ‘goodness’ score can be assessed (for example, based on reduced build time and improved compliance with thermal profile) for a proposed arrangement of deposit instructions, and then myriad re-arrangements can be tried to reach an optimal or acceptable score. Some techniques may start from complete randomness, whereas others may start with the organized list produced by sorter 78. The explorative algorithms may then perturb the starting arrangement with minor changes and recalculate the score, systematically testing a large number of sequences in constant pursuit of a ‘better’ alternative sequence having an improved score. In some techniques, a trend in improved scores may be detected to result from a certain pattern of action, such as concentrating deposit occurrences in a particular place and time. Once this phenomenon is recognized, an iterative goal-seeking algorithm may continue to explore adding other similar alterations until no further score improvement is achieved.

To illustrate another aspect useful in some implementations, FIGS. 30A through 30D depict various alignments between an object contour 3002 and a pattern of voxel locations 3004, which may be likened to the situation presented earlier in FIG. 19. In each of FIGS. 30A through 30D, a set of shaded voxels, such as voxel space 3012, are shown to partially extend beyond or outside of the object layer contour 3002. The shaded voxels in this view are intended to show the subset of required voxels that are necessary to ensure that, in the finished blank part, there will be material present at every point along contour 3002. Unlike the view of FIG. 19, however, the voxels that are wholly contained within the interior of contour 3002 are hidden to emphasize the protruding portions of the edge-forming voxels. For each of FIGS. 30A through 30D, a label 3031 indicates an estimate of the relative amount of excessive material that will be printed when the required voxel spaces are filled. In particular, shaded voxels 3012 are shown occluded by contour 3002 to emphasize the degree to which filling those specific voxel's creates material excess material outside contour 3002. Note that, for some edge-lining voxel spaces, the majority of the space lies outside the contour 3002 but those voxels are nevertheless required for creating the final part without voids.

In FIG. 30A, a first possible alignment between pattern 3004 and contour 3002 is shown and, as indicated by label 3031a, the approximate voxel volume extending beyond the contour is 10.55 units. (For illustrative purposes in the context of the regular pattern of voxel boundaries in pattern 3004, a ‘unit’ here is simply by comparison to the area of one whole voxel space 3012, which is proportional to the volume at a fixed layer height.) In a slightly different alignment shown in FIG. 30B, the approximate volume of the filled voxels that extend beyond contour 3002 increases to 11.95 units (see label 3031B). The alignment shown in FIG. 30B represents a repositioning in along two axes it within the plane of the pattern 3004 ending in a different relative position than that shown in FIG. 30A. FIG. 30C reflects yet another positioning between pattern 3004 and contour 3002 wherein pattern 3004 has at least been rotated in comparison to contour 3002. With the alignment shown in FIG. 30C, the estimated excess volume deposited for this layer is 12.20 units. Finally, in FIG. 30D, an alignment is represented wherein pattern 3004 has been scaled slightly larger (but within the limits of the size of deposits that can be reliably made within each voxel location) and is shown in a tentative alignment with contour 3002 to yield an estimated excess of material to be printed of 10.50 units (taking into account the pattern scaling factor for a meaningful comparison), which is the lowest of the four estimates shown thus far. Through additional transformations of the pattern and the relative positions between contour 3002 and pattern 3004 it may be possible to achieve an even lower degree of excess deposit mass. Reducing the excess amount of material printed at least reduces consumption of material and the requirement for machining the excess material from the blank in a secondary process as depicted in FIG. 11 and described. elsewhere herein. It is considered generally desirable to minimize the amount of excess material printed or deposited to form a specific monolayer of mass deposits.

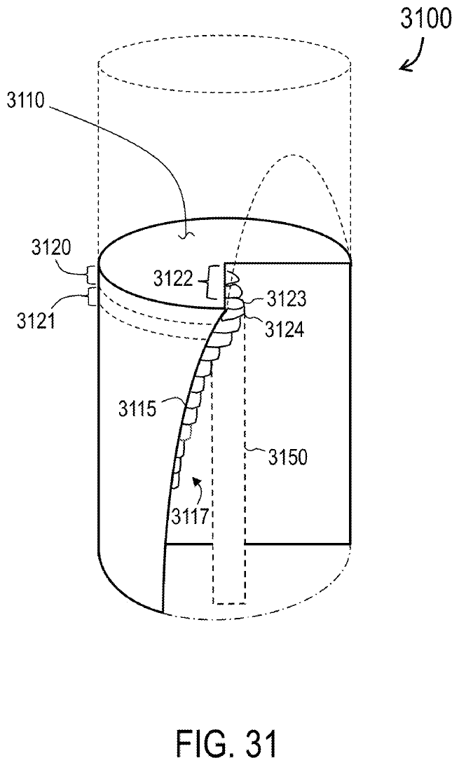

FIGS. 30A through 30D demonstrate advantages to be gained by shape and orientation transformations upon pattern 3004 to achieve a good overlay onto each layer independently of adjacent layers. However, the flexibility to perform these transformations as a benefit of the present teachings may be far more significant in view of the circumstances depicted in FIG. 31.

In FIG. 31 a model of an object 3100 is depicted partially as an outline (similar to FIG. 10A) and partially in solid form to represent an intermediate stage in the progress of additively forming the object. (For clarity, some parts of the solid portion are shown as having smooth final-part surfaces rather than the irregular surface that would actually be present more like FIG. 11.)

The top surface 3110 of the solid portion formed so far is shown to resemble contour 3002 in FIG. 30A. Importantly, in FIG. 31, a curved overhang 3115 is depicted which creates specific challenges for forming surface 3117 as a concavity with an overhang on the part. As successive layers 3120 are formed by material deposits, it may be imperative to minimize the amount of excess material deposited along edge 3122 even at the expense of increasing excess material deposits elsewhere along the contour of top surface 3110. As contour 3115 is formed, some deposits on the periphery, along features analogous to edge 3122, may be unsupported from underneath and may be subject to falling, slumping or failing in other ways.

Referring hack to FIG. 30B briefly, it is evident that a particular voxel, such as shaded voxel space 3040 in FIG. 30B or shaded voxel space 3041 in FIG. 30C would be at risk for being deposited without any underlying support if they were to be deposited at corresponding location 3123 shown in FIG. 31. One possible way to support, for example, deposit at voxel space 3041 shown in FIG. 30C is to ensure that previous deposit layers, such as layer 3121, have provided for a similar overhanging deposit 3124 and, for support purposes as the overhang slope becomes more severe, it is likely that this pattern of placement of excess material must be observed for many preceding in forming the concavity of surface 3117 and outer contour along curved overhang 3115. Alternatively, providing support for excess material that is placed along edge 3122 may involve building a separate support structure 3150 to provide support for material at location 3123 and other nearby voxel locations that are along edge 3122. Of course, building a parallel structure 3150 merely to provide support for mostly excess deposit locations, such as voxel space 3040, reduce efficiency in build time and material consumption. In contrast, aligning and resealing pattern 3004 relative to contour 3002 (as shown in FIG. 30D) may reduce or eliminate the need to provide previous layer supports at location 3124 and may alleviate the need to provide for a separately built support structure 3150 that would be discarded later. Thus, in some circumstances the differences in excess material shown between FIGS. 30A and 30D may be far more dramatic in the case where there are overhangs involved in creating the part. In FIG. 30B, although the indication is that, when viewed as single layer, the estimated excess material amounts to about 11.95 units, the reality may be that aligning pattern 3004 an contour 3002 in this manner, necessitating material fill into voxel space 3040, results in hundreds or thousands of units of excess printing due to the presence of an overhang. Accordingly, it is advantageous to be able to freely align the voxel pattern as needed layer-by-layer and achieve optimizations in consideration of adjacent layers.

FIG. 32 depicts a process for evaluating numerous prospective alignments as were shown in FIGS. 38A through 30D and identifying suitable alignments by which a specific array of voxel spaces may be transformed to more efficiently form a layer of a blank part. In particular, FIG. 32 shows a process 3200 which effectively evaluates a number of possible alignments and then modifies or renders a sequential list of deposit locations representing a favorable arrangement to reduce the amount of excess material being added to the blank. Process 3200 preferably eliminates, where possible, the need to print a separate support structure 3150 as might otherwise result from a poor choice of alignments between voxel pattern 3004 and contours 3002.

Process step 3202 commences upon the need to decide upon an optimum or suitable alignment between a voxel location pattern and a given contour corresponding to one layer of an object to be built. In other words, process 3200 seeks to perform a type of goal-seeking and selection that was conceptually described with respect to FIG. 30A through 30D. Once commenced in step 3202, execution of process 3200 immediately proceeds to step 3204 to obtain a two-dimensional (2D) model slice depicting the object contours at a given layer elevation. This would correspond to object contour 3002 in FIGS. 30A through 30D or to object contour 1902 shown in FIG. 19. Once the 2D model slice has been obtained, then step 3206 is performed to procure a pattern of voxel boundaries, such as pattern 3004 shown earlier. Next, in step 3208, the pattern is overlaid onto the model slice at a first relative positioning, such as that shown in FIG. 30A. Then, in step 3210, specific required' voxels are identified for inclusion in a list of layer deposits as was described in conjunction with FIG. 19 earlier.

In step 3212, voxel spaces in the pattern that are required to be filled to fully meet the object contours are compared to the object contour (see contour 3002) and the area or volume of material extending beyond the contours is assessed. These protruding areas or volumes are added together to derive an excess material value or the like. In step 3214, an alternative positioning is tested by one or more transformations including: translating in one or both of the dimensions in the plane of the pattern 3004, rotating the pattern as shown in FIG. 30C or by scaling the overall pattern as shown in FIG. 30D. In step 3216, analogously to step 3210, a set of required voxels is determined that ensure that there is material along the object contours and. then, in step 3218, a second excess material value is calculated in a comparable manner as in step 3212.

Process 3200 next operates to compare the first excess material value versus the second excess material value and determine which one of the two prospective alignments has the lowest excess value or is otherwise most favorable. Decision block 3220 is performed to compare the first excess material value to the second excess material value. If the second alignment results in no improvement compared to the first alignment determined in step 3212 then execution simply returns to block 3214 to explore a different ‘second’ relative positioning being altered from the previously tested ‘second’ candidate in terms of at least one of translation, scaling or rotation parameters. Step 3220 essentially implements an iterative search among possible different alignments.

Note that, as in the scenario described earlier wherein the overall part has an overhang along edge 3122, the assessments of excess material in steps 3212 and 3218 may take into account certain parts of the contour where the impact of excess material is far greater than for other parts of the contour. One way to take this into account is to add the number of units underneath an overextended or overhung voxel. For example, in FIG. 30B, the estimated overage of 11.95 units would also suffer the penalty of the underlying structure 3150 needed to support material at voxel space 3040, causing a strong disadvantage towards employing the alignment shown in FIG. 30B versus one of the other choices.

If, in step 3220, it is determined that the second alignment tested by steps 3214, 3216, 3218 results in an overall reduction in the amount of excess material, then step 3222 is performed whereby the second relative positioning effectively overtakes the first relative positioning as a most favored candidate for final positioning. Next, in step decision block 3224, a determination is made as to whether the newly adopted ‘best so far’ relative positioning is adequate or whether the process of optimization needs to continue in testing additional potential relative positionings by further iterating steps 3214 -3218. If, in step 3224, it is determined that the relative positioning identified in step 3222 is indeed adequate or optimal, then execution proceeds to step 3226 to conclude the role of process 3200 in determining positioning for voxel pattern 3004 relative to the object's contours for a subject layer. The resultant list of required voxels, with locations particularly adjusted by the action of process 3200, is then provided to sorter 78 for further processing as has already been described.

Process 3200 involves exploring or finding improved or optimum adjustments to, for example, translation along two axes, rotation in one axis and 2D scaling by a scalar multiplier. There are four degrees of freedom, visually evident in FIGS. 30A-30D, that may be adjusted to improve efficiency of coverage. Various techniques may be used to find acceptable or even optimum adjustments of these four transformations of pattern 3004 in application to a given contour 3002. As mentioned earlier there are stochastic processes, for example, that may work to find improved or optimum solutions.

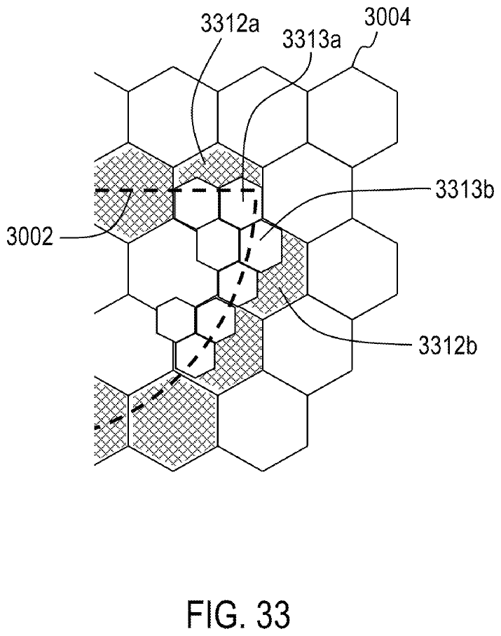

FIG. 33 depicts an alternative manner of reducing excess material in the situation that was originally shown in FIG. 30D. Thus far for simplicity, only regular arrays of voxel spaces have been presented, such as pattern 3004 in FIG. 30D. However, some material deposition processes, such as CMT, can produce consistent point deposits over a range of deposit volumes. This allows for interspersing different deposits sizes to fill in a layer, which may provide added benefits as follows.

In FIG. 33, shaded portions of voxel spaces 3312a, 3312b correspond to shaded voxel spaces in FIG. 30D. Overlaid in the same vicinity, and partially occluding voxel spaces 3312a, 3312b, are smaller sized hexagonal shapes 3313a, 3313b which represent alternatively located and sized spaces into which material could be deposited. Doing so would reduce the amount of excess material printed (as evident by the shaded areas that remain visible) while still satisfying the requirement to provide material at all points along contour 3002. FIG. 33 is a conceptual diagram showing only a partial solution for filling inside of contour 3002. it should be made clear that, for build efficiency, the entire layer need not be re-implemented using such small deposit spaces. it is more likely that a mixture of small peripheral and large central deposits within a single layer may achieve a more advantageous balance between contour adherence and build speed. In some processes, it may be desirable to transition from areas of large deposits to areas of smaller deposits gradually. Some implementations may allow for cell generator 74 to create a distorted cell field or for later processes to adapt the cell field into irregular patterns, perhaps involving irregular patterns of mixed n-gons rather than strictly hexagons. Various alternative tessellations may be created for a given contour 3002 which result in finer cell sizes around the perimeter compared to interior portions. For example, Voronoi or Laguerre tessellations may be constructed to outline voxel spaces as long as the range of volumes to be filled with material remain compatible with the depositor's capabilities.

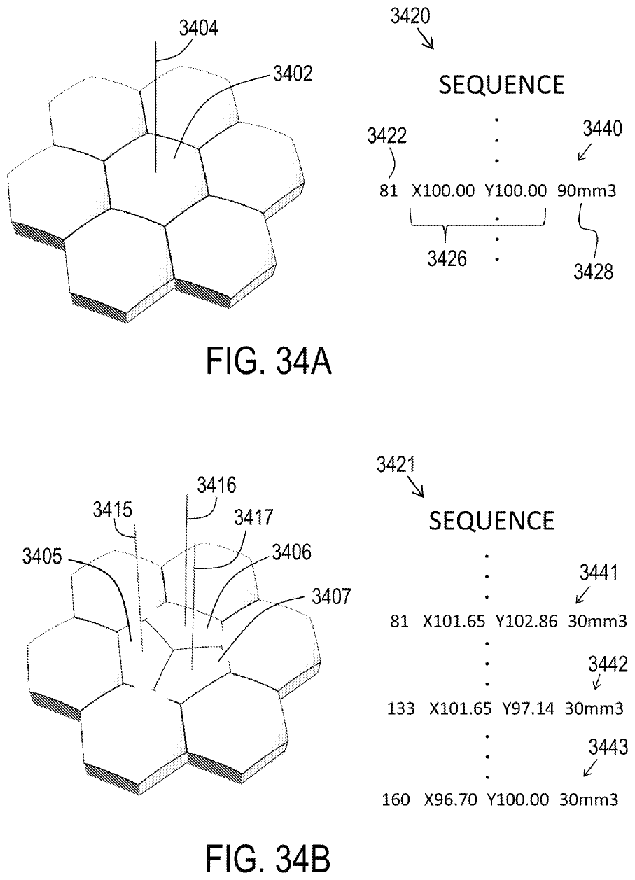

FIGS. 34A-34B depict what may be termed ‘voxel splitting’ as another way of implementing multiple deposit sizes within a given layer of deposits. In FIG. 34A, a central voxel space 3402 is shown to be surrounded by other unspecified voxels, all of which are depicted as if filled with deposited material. For illustrative purposes, voxel space 3402 is taken to correspond to the voxel labeled with sequence number ‘81’ in FIG. 26.

A singular nominal XY location for voxel space 3402 is depicted by centerline 3404, which may be likened to the role of line 2131 shown in FIG. 21. This is the XY position to which a depositor will move so that material can then be deposited into voxel space 3402.

An accompanying excerpt of a sequential list 3420 is shown to list a record 3440 that directs the depositing of material into the voxel space labeled ‘81’ (see field 3422) and that indicates, in a ‘volume to deposit’ field 3428, that 90 cubic mm are to be deposited at that location shown in XY location field 3426.

For the sake of explanation, it is now assumed that the voxel space 3402 (labeled ‘81’) is indeed within the ‘hot spot’ region as was depicted in FIG. 26 and that some mitigation is required. FIG. 27 represented one approach to control temperature in the region by re-sequencing the order in which whole voxel volumes were filled. FIG. 34B shows another method wherein the single voxel space 3402 (formerly labeled ‘81’) is effectively replaced by three smaller voxel spaces 3405, 3406 and 3407, each with a distinct nominal location as indicated by their respective centerlines 3415, 3416, 3417. Furthermore, as indicated in a now-altered sequential list 3421, the filling of these three smaller voxels is reflected as three separate records 3441, 3442, 3443 that are placed far apart in the temporal sequence, have distinct XY locations and specify one third of the ‘volume to deposit’ compared to original record 3440. The combination of dividing the energy injection into thirds and scattering the deposit times affords even greater reduction in temperature rise within the problematic hot zone of FIG. 26. These measures may be applied for some or all of the voxel spaces within the region or may be used to complement the whole-voxel resequencing explained in FIG. 27.

The approaches for selectively applying variable sized voxels that have been illustrated in FIGS. 33, 34A-34B may be used to implement optional step 2816 in process 2800.

FIG. 35 pictorially describes a process flow 3500, in accordance with preferred embodiments, for facilitating the formation of a finished part 3599 from a digital data model 3510 representing the shape of a desired finish part. Model 3510 is shown (by arrow 3509) to be initially provided as input to a composite process 3511 comprising, for example, the roles of slicer 72, cell generator 74, masker 76 as were introduced earlier in FIGS. 12 and 13. As described elsewhere herein, a resulting listing of voxel spaces required to be included in the model are then provided (see arrow 3521) to a subsequent organizing process 3522, such as sorter 78 introduced earlier. Organizing process 3522 may comprise any of the sorting, sequencing or resequencing features, algorithms, heuristics other actions described anywhere else within the present disclosure. The output of the sorting or organizing step 3522 results in a sequential list of deposit locations 3523 and serves as instructions for the actual formation of a blank by fabrication system 10 as represented by block 3524.

Arrow 3525 represents the passage of a rough blank (visually resembling the as-deposited model depicted in block 3520) to a subsequent process of machining or subtractive manufacturing (see block 3526 corresponding to block 80 shown in FIGS. 12 and 13 earlier) which results in the finished part 3599.

To produce the final part, the machining processes represented by block 3526 are carried out according to machining instructions (arrow 3527) that have been calculated by a CAD/CAM computing application 3530. Machining instructions may comprise tool paths for moving cutting tools against the blank part until it is trimmed to the final shape specified by model 3510.

Returning to composite process 3511, arrow 3508 represents that the raw voxel list, in some form, may also be provided to a rendering tool, algorithm or software process to create a 3D model, ‘as-deposited’ model 3520, describing the anticipated outer shape of the blank that will be produced when additive fabrication in block 3524 takes place based on instructions 3523. This as-deposited model 3520, which may be an SU, formatted file or any other suitable data structure, is derived from the list of required voxels but may or may not be visually rendered to a human end user. In some implementations, a view of the as-deposited model 3520 may be generated and integrated into a user interface, for presentation to an end user during the performance of the processes within composite process 3511.

As a particular advantage in accordance with the present teachings, CAD/CAM application 3530 is not only provided with the 3D model of the finished part 3510 (arrow 3531) but is also further provided with the as-deposited model 3520 as indicated by arrow 3532. The creation of an additional model 3520 for the additively manufactured blank 3525 usefully allows for CAD/CAM application 3530 create optimal tool path instructions 3527 and dramatically improve the efficiency of performing machining processes 3526. Providing both types of models to CAD/CAM application 3530 as shown enables improved tool selection and tool path calculations that are markedly different than tool paths that would be generated otherwise. Traditional approaches to operation of CAD/CAM application 3530 without the benefit of as-deposited model 3520 may create wasteful tool paths under the assumption that finished part 3599 is to be machined from a large solid billet. Alternatively, CAD/CAM application 3530 may be left to assume that, as with extrusion-based additive manufacturing, the as-deposited part to be machined would already conform closely to the layer-by-layer contours of the part. Trying to operate under the latter assumption upon a blank part that has been formed by discrete deposits as described herein might result in directing a small spindle-mounted tool to plunge deeply into the blank, risking tool breakage or violent ejection of large pieces of loose material. The present teachings as to providing an as-deposited model 3520 to CAD/CAM application 3530 allows for well-informed tool selection and calculation of machining tool path instructions 3527 in view of the possibility of substantial outcroppings of excess material along certain parts of the model. In particular, a CAD/CAM application may take into account a maximum depth-of-cut for a given material-removal tool that will be used for machining processes 3526 and selectively create multiple-pass toolpaths at locations where the as-deposited model 3520 indicates an outcropping of deposited material beyond model 3510 that is greater than the maximum depth-of-cut. In some integrated manufacturing systems, the additive fabrication 3524 and machining processes 3526 may take place in a common work center or machining processes 3526 may operate within the build space of additive fabrication 3524.

Testing was performed using a 6-axis robotic weld cell with a GMAW power supply using 0.045″ diameter ER7OS filler wire with 15 mm stick out and a 90/10 Argon/CO² shielding gas flowing at 25 CFH. Four separate tests were performed: 1) a DoE varying wire feed speed and arc on time to understand the variety of cell sizes possible with the process, 2) a series of 100 cells using identical parameters in order to characterize repeatability of the process, 3) tests varying the overlap and positioning of cells required to build a three-dimensional block, and 4) a comparison of residual stress and distortion between the proposed architecture and a standard WAAM process. With the exception of the stress test, all tests used 6″×6″×0.375″ hot rolled A36 steel base plates.

### Example 1

Summary of Initial Process Development 2.2.1 Cell Size DoE

Arc-on time and wire feed speed were varied to evaluate the range of cell sizes that could be generated by the equipment in the welding cell. Arc-on times ranged from 100 to 1,000 milliseconds (ms) in 100 ms increments, while wire feed speeds were varied from 100 to 300 inches per minute (ipm) in 50 ipm increments. The test was performed twice and the average height, diameter, and aspect ratio of each combination of arc-on time and wire feed speed was calculated.

Cell size (both diameter and height) increased with respect to both time and wire feed speed. Diameters ranged from 2.85 to 7.3 mm, while the average height ranged from 0.95 to 3.12 mm. This wide range of cell sizes suggests that there is a wide process window that can be utilized to fine tune the cells not only in terms of size, but in terms of heat input and microstructure. The diameter to height aspect ratios ranged from 1.72 to 3.38, with the largest aspect ratios correlated to cells produced with short arc-on times and high wire feed speeds. While aspect ratios of 4 to 5 are suggested to be the minimum allowed to avoid macroscopic lack of fusion between weld beads, the relatively low aspect ratios observed were attributed to the “cold” nature of the short circuiting CMT process. The aspect ratio could be increased by changing wire feed speed, stick out, and shielding gas in order to change the arc characteristics away from a short circuit and towards a spray, globular, or pulsed mode. Some voids were present on top of larger cells suggesting that the base plates were dirty and/or insufficient shielding gas was present. This is unsurprising as the weld cell automatically turned the gas on and off during the move time between each cell. Running the shielding gas continuously to maintain an inert environment surrounding the process may prevent such voids.

### Example 2

Two sets of parameters (i.e., “small” and “large) ”were down-selected from Example 1 to continue testing. Both cell sizes were generated using a wire feed speed of 300 ipm, with an arc-on time of 100 ms for the small cells and 900 ms for the large cells. 100 cells were produced with each set of parameters, and the heights and diameters were measured with calipers. Average heights, diameters, and aspect ratios were calculated.

Statistical analysis for both sets of cell sizes showed a relatively normal distribution in terms of diameter, height, and aspect ratio. The average diameter and height of the 100 ms cells were 4.69 and 1.33 mm respectively, while the 900 ms cells had an average height and diameter of 7.42 and 3.06 mm respectively.

Three sigma manufacturing control analysis for each of the two sizes shows that the process is controllable, as none of the cells measured were found to fall outside of the control limits. The manufacturing control plot of the small cells shows no trends with respect to the order in which cells were generated. This is likely due to the low heat input generated by these cells, as the manufacturing control plot for the large cells shows that the cell aspect ratio increased as additional cells were produced. The diameter remained the same, while the cell height decreased as additional cells were produced. An increase in the starting temperature means that there is excess thermal energy in the deposition (i.e., the energy input from the GMAW process remains constant), which melts more of the material around the cell, thus increasing the diameter while reducing height. Thus, it was inferred that the overall temperature of the plate increased as the test progressed due to the higher heat input used to generate large cells.

### Example 3

Once the average diameter and height were calculated for each set of parameters, the slicing software was implemented to write code to test the effects of cell overlap and stacking on the architecture's ability to build three dimensional blocks. Cell placement was randomized by the slicing software within a hexagonal array, while cell overlaps were varied from 0-40% of the cell diameter for both small and large cells. Thin two-layer blocks were built first to determine a visually acceptable level of overlap, followed by a full size block measuring 25 mm×100 mm×12 mm. The final block was then cross sectioned and polished using standard metallographic techniques for macro- and microscopic evaluation.

The first overlap tests were performed with the small 100 ms cells. The cells rapidly placed in close proximity resulted in a propensity to agglomerate and become asymmetric. An initial assumption was made during testing that the agglomeration was due to the low heat input of the small cells, and no further testing was performed with the small cells at that time. Overlap testing performed with the larger 900 ins cells showed visually acceptable results at a 20% overlap of cell diameter (i.e., overlap of the cells within the same layer). The initial layers of the large block had a much rougher upper surface than the final layer of the full-size block. This effect was reduced in the full size block as the overall temperature of the component increased during the build. In-situ human observation of the process revealed that the agglomeration effect seen in the small cells was still occurring when cells were generated in close proximity, regardless of the layer. The last cells deposited in each layer were observed to wet evenly to all sides as they filled in divots left by the surrounding hexagonally patterned cells. This suggests that the agglomeration effect can be overcome by changing the order in which cells are deposited from a fully random sorting to a semi-randomized sorting pattern which will ensure that no two cells are generated immediately in close proximity.

Macroscopic evaluation of the block revealed a welding defect—lack of fusion—between cells. The lack of fusion appeared to be more frequent on the initial layers of the build, likely due to the lower overall temperature of the component. This is not surprising, as the CMT process uses the short-circuit transfer mode, which is prone to lack of fusion. Lack of fusion in the cell-arc process can be overcome by changing the aspect ratio of each individual cell or increasing the heat input of the process by changing to different GMAW transfer mode such as spray transfer.

Microscopic evaluation showed that the steel microstructure underwent significant recrystallization as it is reheated by the cells surrounding it on all sides. The recrystallization occurred as underlying cells were reheated and tempered, thus forming a highly desirable tough, fine grained microstructure.

### Example 4

Magnitudes of residual stress were compared between blocks built with three different cell parameter sets (Inventive Examples 1-3) and a conventional low-heat input CMT linear weld (Comparative Example). For each of Inventive Examples 1-3 (IE1-IE3) and the Comparative Example (CE), long, thin blocks measuring 0.5″×10″×0.5″ were each produced on a 2″×12″×0.125″ plate to minimize the restraint provided. by the base plate and maximize distortion generated by the block. Each build plate was weighed before and after each block was deposited, and the total time required to build each block and the final temperature of each sample were recorded. Energy input was calculated based on welding parameters and known arc and melting efficiencies for the GMAW process. Table 1 shows various process parameters for IE1-IE3 and. CE.

TABLE 1

| | | | Wire | | | | | |
|---|---|---|---|---|---|---|---|---|
| | Arc On | Duty | Feed | | Travel | Deposit | | |
| | Time | Cycle | Rate | Total # | Speed | Speed | Amperage | Voltage |
| Block | (ms) | (%) | (ipm) | Cells | (mm/s) | (mm/s) | (A) | (V) |
| IE1 | 100 | 17.8 | 300 | 2860 | 450 | N/A | 203 | 13.1 |
| IE2 | 500 | 52 | 300 | 750 | 450 | N/A | 203 | 13.1 |
| IE3 | 900 | 66.1 | 300 | 420 | 450 | N/A | 203 | 13.1 |
| CE | N/A | 100 | 100 | N/A | N/A | 3 | 88 | 10.4 |
| | Total | | | | | | | |
| | Energy | Energy | Energy | Build | Final | Material | Deposition | |
| | Input | per Cell | Density | Time | Temp | Deposited | Rate | Measured |
| Block | (J) | (J) | (J/mm³) | (min) | (° C.) | (lb) | (lb/hr) | Distortion |
| IE1 | 380280 | 133 | 11.45 | 50 | 320 | 0.577 | 0.69 | 1.2 |
| IE2 | 498619 | 665 | 14.69 | 18 | 540 | 0.590 | 1.97 | 0.6 |
| IE3 | 502608 | 1197 | 15.44 | 13 | 535 | 0.566 | 2.61 | 0.3 |
| CE | 686400 | N/A | 23.43 | 25 | 270 | 0.509 | 1.22 | 3 |

Distortion was measured by placing the each sample on a flat surface and measuring the amount of deflection between the surface and the high points of each build plate. Test results showed that 1E3 exhibited the lowest amount of distortion, thus containing the least residual stress of all samples. Distortion was found to increase as the arc on time per cell diminished. CE contained the largest amount of distortion. The total energy inputs, deposited weight, and volume of all samples used to produce all samples were approximately equal. The duty cycle and energy input per cell were strongly correlated to the final temperature, and inversely related to the measured distortion of each sample. While the total energy input, energy density, and final temperature of IE2 and IE3 were approximately equal, the energy per cell in IE3 was twice that of IE2, while the distortion measured in IE3 was half that of IE2. This suggests that the energy input per cell is influential in controlling residual stress.

The most critical factors affecting residual stress in this test were energy input per cell and the ratio of the weld bead area to the area of surrounding material. In light of these test results, without being bound by theory, the residual stress was reduced substantially in the cellular, non-continuously deposited. samples, IE1-IE3, compared to the linear sample, CE, for two primary reasons: 1) the temperature gradient between each cell and the component is lower than traditional linear welding processes thanks to the ability of the randomized cell architecture to distribute energy evenly throughout a component, and 2) the lack of linear stress buildup during deposition by eliminating linear deposition paths in favor of even distributed small, circular weld beads. The cell-based architecture resulted in substantially lower residual stresses than the conventional arc-based DED processes, and residual stress and distortion can be controlled by controlling the amount of energy input per cell.

In various embodiments disclosed herein, a single component can be replaced by multiple components and multiple components can be replaced by a single component to perform a given function or functions. Except where such substitution would not be operative, such substitution is within the intended scope of the embodiments.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices known in the art. Rather, it is hereby intended that the scope be defined by the claims appended hereto. Also, for any methods claimed and/or described, regardless of whether the method is described in conjunction with a flow diagram, it should be understood that, unless otherwise specified or required by context, any explicit or implicit ordering of steps performed in the execution of a method does not imply that those steps must be performed in the order presented and may be performed in a different order or in parallel.

What is claimed is:

1. A process for forming a three-dimensional object within a build space from at least one feedstock material and according to a first digital data model describing at least the object's outer surface, comprising:
defining an array of voxel spaces spatially dividing the build space in three dimensions;
identifying a required subset of voxel spaces in the array that must be occupied by the feedstock material such that feedstock material is present at all points along the object's outer surface according to the first digital data model;
using an additive process to build a blank version of the object by performing discrete deposits of feedstock material at least at locations that correspond to the required subset of voxel spaces;
constructing a second digital data model representing a concatenation of the outer shapes of at least the voxel spaces in the required subset of voxel spaces;
providing the first digital data model and the second digital data model as input to a tool path computing application, wherein the tool path computing application produces a list of motion instructions to direct a material-removal tool to remove material from the blank version of the object to yield a final version of the object in accordance with the first digital data model; and
outputting the motion instructions to move the material-removal tool to remove material from the blank version of the object until a final version of the object is formed in accordance with the first digital data model.

2. The process of claim 1 wherein the spatially dividing of the build space along one of the three dimensions is defined by a build layer thickness and wherein the performing of discrete deposits comprises depositing a unitary mass of feedstock material having a dimension corresponding to the build layer thickness.

3. The process of claim 1 wherein the discrete deposits of feedstock material are performed in a sequence arranged such that consecutively ordered discrete deposits are at locations corresponding to non-adjacent voxel spaces.

4. The process of claim 1 wherein the discrete deposits of feedstock material are performed in a sequence arranged such that, for each pair of consecutively performed first and second deposit locations corresponding to first and second voxel spaces, the second voxel space does not adjoin the first voxel space.

5. The process of claim 1 wherein a vicinity for each voxel space is defined by a nominal boundary radius ‘R’ and, for each pair of consecutively performed first and second deposit locations, a distance between the first and second deposit locations is at least three times R.

6. The process of claim 1 wherein at least one portion of the second digital data model extends beyond the first digital data model by greater than a maximum depth-of-cut dimension of the material-removal tool and wherein the motion instructions comprise multiple passes by the material-removal tool to remove the portion.

7. A non-transitory computer-readable medium comprising:
a computer program code segment that, when executed by a computer, receives a first digital data model describing an object's outer surface in three dimensions;
a computer program code segment that, when executed by a computer, compares the first digital data model to a three-dimensional array of voxel spaces that subdivide a space encompassing the object's shape;
a computer program code segment that, when executed by a computer, to identifies, from the array of voxel spaces, a subset of the voxel spaces required to fully occupy a volume bounded by the object's outer shape;
a computer program code segment that, when executed by a computer, generates a second digital data model as a concatenation of all voxel spaces in the subset.

8. The non-transitory computer-readable medium of claim 7 further comprising:
a computer program code segment that, when executed by a computer, compares the second digital data model to the first digital data model to identify where the second digital data model indicates excess volumes beyond the object's shape according to the first digital data model; and
a computer program code segment that, when executed by a computer, generates and outputs motion instructions to guide a material removing tool to selectively remove excessive material from a blank part, that resembles the second digital model, to form a final part conforming to the first digital data model.

9. The non-transitory computer-readable medium of claim 8 wherein the generating and outputting motion instructions further comprises detecting at least one portion of the second digital data model extending beyond the first digital data model by greater than a maximum depth of cut dimension of the material-removal tool and, responsively, including motion instructions, localized to the vicinity of the portion, providing for multiple passes by the material-removal tool to remove the portion.

10. A system for forming a three-dimensional object within a build space from at least one feedstock material and according to a first digital data model describing at least the object's outer surface, comprising:
a non-continuous deposition additive manufacturing apparatus comprising:
at least one depositing component for performing discrete deposits of the feedstock material;
a first motion system coupled to the depositing component and operable to programmatically move the depositing component to locations within the build space; and
at least one computer application executing in a computer processor which:
aligns the first digital data model with an array of voxel spaces and identifies a required subset of voxel spaces in the array that must be occupied by the feedstock material in forming a blank part so that feedstock material is present at all points along the object's outer surface according to the first digital data model;
generates first motion instructions for directing the non-continuous additive manufacturing apparatus to perform discrete deposits at least a set of locations corresponding to the required subset of voxels; and
generates a second digital data model representing an alternative outer surface of the blank part that is collectively formed by the voxel boundaries of the required subset of voxels.

11. The system of claim 10 wherein the computer application compares the second digital data model to the first digital data model and calculates second motion instructions for controlling a material-removal tool to remove excess material from the blank part until a final version of the object is formed in accordance with the first digital data model.

12. The system of claim 10 further comprising at least one material-removal system operable to act according to the second motion instructions and to remove the excess material from the blank part.

13. The system of claim 12 wherein the at least one material-removal system operates within the build space of the additive manufacturing system.
